SEQUENCE LISTING (10 sequences)

SEQ ID NO: 1 - DNA, 24 bp, Artificial Sequence
  PCR PRIMER
atgccagcacctaacccctaatgt

SEQ ID NO: 2 - DNA, 20 bp, Artificial Sequence
  PCR PRIMER
ggaccgcaaggtgggcggga

SEQ ID NO: 3 - DNA, 20 bp, Artificial Sequence
  PCR PRIMER
tgctctactgggccacgttc

SEQ ID NO: 4 - DNA, 21 bp, Artificial Sequence
  PCR PRIMER
tgcgggtctgcggtggagtct

SEQ ID NO: 5 - DNA, 23 bp, Artificial Sequence
  PCR PRIMER
tgtggtgtagggaacggcctgag

SEQ ID NO: 6 - DNA, 24 bp, Artificial Sequence
  PCR PRIMER
cttcctggaggtcacggctcaagg

SEQ ID NO: 7 - DNA, 18 bp, Artificial Sequence
  PCR PRIMER
cgtgtatgatccctgcag

SEQ ID NO: 8 - DNA, 21 bp, Artificial Sequence
  PCR PRIMER
gctcatgagaagaatggagtg

SEQ ID NO: 9 - DNA, 22 bp, Artificial Sequence
  PCR PRIMER
cccaggctgctccagaaacatg

SEQ ID NO: 10 - DNA, 22 bp, Artificial Sequence
  PCR PRIMER
gttcgggacctgggcagttgtg

(19) United States
(12) Patent Application Publication
(10) Pub. No.: US 2013/0029862 A1
(43) Pub. Date: Jan. 31, 2013

(54) Clinical application utilizing genetic data for effective medication management

(71) Applicants: Gareth Davies, Madison, SD (US); Ryan Hansen, Sioux Falls, SD (US)

(72) Inventors: Gareth Davies, Madison, SD (US); Ryan Hansen, Sioux Falls, SD (US)

(21) Appl. No.: 13/488,397

(22) Filed: Jun. 4, 2012

Related U.S. Application Data
(60) Provisional application No. 61/492,795, filed on Jun. 2, 2011.

(51) Int. Cl. C40B 30/04; C40B 40/06

(52) U.S. Cl. 506/9; 506/16

(57) ABSTRACT

The present disclosure relates a predictive method, based on a subject's genetic profile, which defines variability in a specific disease or condition to determine medication response, including determining select VNTR and SNP occurrence combinations which are associated with specific responses to medications, kits and DNA chips/arrays containing such combinations so as to effectuate better medication management.

### CROSS REFERENCE TO RELATED APPLICATION

This application claims benefit under 35 U.S.C. §119(e) to U.S. Provisional Application No. 61/492,795, filed Jun. 2, 2011, which is incorporated by reference herein in its entirety.

### BACKGROUND OF THE INVENTION

1. Field of the Invention

The present disclosure relates generally to pharmacogenetics, and more specifically to a predictive method, based on a subject's genetic profile, that defines variability in a specific disease, disorder or condition to determine medication response, including determining combinations of select VNTR and SNP occurrences which are associated with specific responses to various medicaments, kits and DNA chips/arrays containing such combinations and methods to effectuate better medication management.

2. Background Information

Attention-Deficit/Hyperactivity Disorder (ADHD) is strongly heritable. Based on the results of multiple twin studies conducted worldwide, ADHD has an estimated heritability of approximately 76%. Several reviews and meta-analyses have been published on the involvement of dopaminergic genes in ADHD. Most meta-analyses have shown evidence for the involvement of genes coding for dopamine receptors D4 and D5 (DRD4 and DRD5, respectively), the gene encoding for the dopamine transporter (DAT1 or SLC6A3), and the gene coding for the enzyme dopamine beta-hydroxylase (DBH).

A review of studies on the neurophysiological and neuropsychological effects of DAT1 in ADHD demonstrate inconsistent results. Most studies have compared the 10/10 genotype with other genotypes of this polymorphism in the 3′ UTR and did not find differences in neurophysiological and neuropsychological measures. In some cases, ADHD patients with the 10/10 genotype performed worse than ADHD patients with other genotypes on measures of attentional asymmetry, response variability, vigilance and EEG activity in response to methylphenidate. However, contrary findings have also been reported, in which ADHD patients with the 10/10 genotype performed better than ADHD patients with other genotypes.

Thus, it has been difficult to discover the genetic variants accounting for genetic risk, probably because multiple genes and gene combinations contribute. As a result, clinical linkage analysis and association studies have progressed rather slowly in discovering functional polymorphisms in candidate genes.

In addition to the challenge of assessing an individual's risk of developing a mental disorder, another great clinical challenge is treating mental disorders and selecting the appropriate therapeutic agent. In usual clinical practice, this is largely trial and error, or drugs are chosen based on side effect profiles. There is also concern that many patients may never receive the agent that would best benefit them. There is therefore also a great need for a predictor that would aid clinicians in these difficult choices.

Functionally relevant polymorphisms in candidate genes have the potential of classifying patient populations according to genetic factors, as a means for improving prediction of risk, prognosis, selection of drugs most likely to be active, and guiding drug development through preclinical and clinical trials (enhancing efficacy in a target population and reducing therapy failure or adverse effects).

What is needed, then, are pharmacogenomic tools that will allow for more accurate medication treatment when a patient is initially diagnosed with a particular disease or condition, including providing better medical management for patients who are experiencing side effects or difficulty in identifying an effective treatment for their disease or condition to achieve enhanced patient outcomes, patient satisfaction and further empower physicians to determine immediate and more effective treatment recommendations for their patients.

### SUMMARY OF THE INVENTION

The present disclosure describes a predictive method that defines variability in a specific disease or condition to dictate medication response and therefore assist in remedying the current trial-and-error approach to medication management. This application can cross all medical specialty areas and may be described in combining three separate and distinctive methods.

In embodiments, upon extraction and isolation of an individual's DNA through blood or buccal cells, a combination of genes that are specific to a particular disease or condition are analyzed. In one aspect, these genes will be based on a assortment of genotypes acquired from a custom made open array chip and a number of specific PCR amplifications and detection of VNTR variants within an individual. In a related aspect, single nucleotide polymorphisms (SNPs) of genes that identify genetic variants that determine how an individual metabolizes certain drugs are disclosed, whether through liver cells, epithelial cells of the gastrointestinal tract, lungs, kidneys or skin.

In embodiments, genotypes so determined are compiled in an individual database and analyzed by an algorithm. In one aspect, the algorithm will align the individual genotypes to appropriate clinical pharmacology data that provides for a personalized medication assessment. The algorithms will map out by disease or condition the most effective medication treatment for an individual through prediction of adverse effect risk and medication tolerability to maximize clinical utility. In a related aspect, for an individual disease or condition, the appropriate drug class, and significant insight into the specific medication, and dosage based on a genetic profile is disclosed. Further analysis may also be performed based on a subject's ethnicity regarding all medication considerations described previously.

In embodiments, a simplified assessment may be produced that translates all applicable information that can be utilized by a clinician as a tool to provide more efficient and effective medication treatment and management to a particular patient. In one aspect, the report will provide a personalized assessment based on a subject's genetic profile as to the most effective drug class(es), as well as further insight regarding the specific medication, dosage and potential side effects to aid the clinician for patient treatment in addition to their clinical intuition. Such information may be configured for consumption by the clinician in a user friendly manner such that recommendations presented readily inform their medical judgment.

In embodiments, a method is disclosed for predicting responsiveness to treatment of attention-deficit/hyperactivity disorder (ADHD) in a subject susceptible to developing ADHD with a compound including, but not limited to, methylphenidate, amphetamine, atomoxetine, and bupropion, or a pharmaceutically acceptable salt thereof, including obtaining a sample of body fluid or other tissue from said subject, determining informative occurrences of one or more variable number of tandem repeat (VNTR) polymorphisms present in genes including, but not limited to, human dopamine transporter 1 (hDAT1; NM_{—}001044.4), human dopamine receptor D4 (hDRD4; DQ846850.1), human dopamine receptor D5 (hDRD5; NC_{—}000004.11), human serotonin transporter promoter region (h5-HTTLPR; AC104984) and combinations thereof, and determining informative occurrences of one or more single nucleotide polymorphisms (SNPs) including, but not limited to, hCOMT (rs4680); hSNAP-25 (rs3746544); hNET (rs998424); hNET (rs3785157); hNET (rs47958); hSLC6A2 (rs47958, rs36017, and rs2270935); hSERT (rs25331); hADRA2A (rs1800545) and combinations thereof, in the subject's sample, where the occurrences of the one or more VNTR polymorphisms and the one or more SNPs in the sample are predictive of the subject's response to treatment with the compound or pharmaceutically acceptable salt thereof.

In one aspect, the method further includes confirming whether the subject is susceptible to developing ADHD by determining informative occurrences of one or more SNPs including hBDNF (rs6265); hDRD2 (rs1800497); hDBH (rs1611115); hDBH (rs2519152); hSNAP-25 (rs1051312); hCLOCK (rs1801260); hApoE (rs7412); hNPY (re16139); hTPH2 (rs1386497); hDRD1 (rs265981); hKATII (rs13145318); and combinations thereof.

In another aspect, the compound is methylphenidate, or a pharmaceutically acceptable salt thereof, where the VNTR polymorphisms includes a combination of hDAT1, hDRD4, hDRD5, and h5-HTTLPR, and where the SNPs comprise a combination of hNET1 (rs3785157), hADRA2A (rs180054); hCOMT (rs4680); hSERT (rs25331); and hSNAP-25 (rs3746544).

In one aspect, the method predicts an improved response to the compound when the VNTR polymorphism occurrences include 9 or 10 repeats in the 3′ untranslated region of hSLC6A3 (DAT1); 7 repeats in exon 3 of hDRD4; 4 repeats 18.5 kb upstream of the hDRD5, and where the SNPs occurrences comprise a G allele in the 5′ untranslated region of the HhaI RFLP of the hADRA2A; a VAL/VAL alleles at amino acid 158 of the hCOMT, where the subject is hyperactive or inattentive; and/or T/T alleles at the 3′ untranslated region of hSNAP-25 (rs3746544). In a related aspect, the method predicts a poor response to the compound when the SNPs occurrences comprise A/A alleles in hNET 1 (rs3785157), G/G alleles in hSNAP-25 (rs3746544) and/or C/C alleles in hSNAP-25 (rs1051312).

In another aspect, the compound is amphetamine, or a pharmaceutically acceptable salt thereof, where the VNTR polymorphisms are identified in hDAT1 and where the SNPs include a combination of hNET1, hSLC6A2, and hCOMT (rs4680). In a related aspect, the method predicts an improved response to the compound when the VNTR polymorphism occurrences comprise 9 or 10 repeats in the 3′ untranslated region of hSLC6A3 (DAT1), and where the SNPs occurrences include VAL/VAL alleles at amino acid 158 of said hCOMT, CC alleles at hNET1 36001A/C (rs47958) and the CGC haplotype at 36001A/C, 28257G/C (rs36017), and 28323C/T (rs2270935) in hSLC6A2.

In one aspect, when the methods do not predict improved out come with methylphenidate or amphetamine, the predicted responsiveness is associated with a non-stimulant compound including, but not limited to, atomoxetine or bupropion, or pharmaceutically acceptable salts thereof, and where the VNTR polymorphism includes hDAT4 and the hSNPs include hNET 1.

In another aspect, the method predicts an improved response to the non-stimulant compounds when the VNTR polymorphism occurrences include 7 repeats in exon 4 of hDRD4 (DQ846850.1) and the SNPs occurrences include a G1278A allele at exon 9 in hNET1 (rs3785157). In a related aspect, the method predicts an diminished response to the non-stimulant compounds when the SNPs occurrences include A/A alleles at exon 9 in hNET1 (rs3785157).

In one aspect, responsiveness is determined by comparing one or more symptoms including, but not limited to, inattention, hyperactivity, impulsivity, impatience, blurting, excessive talking, conduct disorder, social impairments and combinations thereof, exhibited by the subject before and after treatment. In a related aspect, an improved response is achieved when the subject exhibits a significant reduction in one or more of the symptoms.

In embodiments, a kit is disclosed including nucleic acids for identifying VNTRs and SNPs associated with a disease or disorder including at least one DNA chip including a plurality of oligonucleotide probes deposited on a solid phase, where the oligonucleotide probes consist essentially of human dopamine transporter 1 (hDAT1; NM_{—}001044.4); human dopamine receptor D4 (hDRD4; DQ846850.1); human dopamine receptor D5 (hDRD5; NC_{—}000004.11); human serotonin transporter promoter region (h5-HTTLPR; AC104984); hCOMT (rs4680); hSNAP-25 (rs3746544); hNET (rs998424); hNET (rs3785157); hNET (rs47958); hSLC6A2 (rs47958, rs36017, and rs2270935); hSERT (rs25331); hADRA2A (rs1800545); hBDNF (rs6265); hDRD2 (rs1800497); hDBH (rs1611115); hDBH (rs2519152); hSNAP-25 (rs1051312); hCLOCK (rs1801260); hApoE (rs7412); hNPY (re16139); hTPH2 (rs1386497); hDRD1 (rs265981); hKATII (rs13145318); optionally two or more primers for PCR of fragments from a genomic nucleic acid sample, which products therefrom hybridize and form complexes with one or more probes on the at least one chip; one or more buffers for forming informative complexes between the resulting PCR products and the plurality of oligonucleotide probes; a manual which provides instructions on the use of the chip and optional primers; and a labeled container for packaging the at least one chip, two or more primers, one or more buffers, and manual.

In embodiments, a DNA chip is disclosed including a plurality of oligonucleotide probes deposited on a solid phase, where the oligonucleotide probes consist essentially of human dopamine transporter 1 (hDAT1; NM_{—}001044.4); human dopamine receptor D4 (hDRD4; DQ846850.1); human dopamine receptor D5 (hDRD5; NC_{—}000004.11); human serotonin transporter promoter region (h5-HTTLPR; AC104984); hCOMT (rs4680); hSNAP-25 (rs3746544); hNET (rs998424); hNET (rs3785157); hNET (rs47958); hSLC6A2 (rs47958, rs36017, and rs2270935); hSERT (rs25331); hADRA2A (rs1800545); hBDNF (rs6265); hDRD2 (rs1800497); hDBH (rs1611115); hDBH (rs2519152); hSNAP-25 (rs1051312); hCLOCK (rs1801260); hApoE (rs7412); hNPY (re16139); hTPH2 (rs1386497); hDRD1 (rs265981); hKATII (rs13145318).

In embodiments, a method of predicting responsiveness to treatment of a disorder or disease with a medicament is disclosed including (a) obtaining a sample of body fluid or other tissue from said subject, (b) determining informative occurrences of one or more variable number of tandem repeat (VNTR) polymorphisms present in select genes and (c) determining informative occurrences of one or more single nucleotide polymorphisms (SNPs) present in select genes in said subject's sample, wherein said occurrences of said one or more VNTR polymorphisms and said one or more SNPs in said sample are predictive of said subject's response to treatment with said compound or pharmaceutically acceptable salt thereof.

### BRIEF DESCRIPTION OF THE DRAWINGS

FIG. 1 shows a flow diagram for predicted responses to methylphenidate using informative occurrences associated with DAT1, DRD4+SERT, DRD5,5-HTTLPR, NET1, ADRA2A, COMT, and SNAP-25.

FIG. 2 shows a flow diagram for predicted side effects of methylphenidate using informative occurrences associated with DAT1, DRD4+SERT, and SNAP-25.

FIG. 3 shows a flow diagram for predicted dosing regimens of methylphenidate using informative occurrences associated with DAT1, DRD4+SERT, and DRD4.

FIG. 4 shows a flow diagram for predicted responses to amphetamine using informative occurrences associated with DAT1, COMT, and NET1, as well as a predicted dosing regimen for amphetamine using the informative occurrences associated with DAT1.

FIG. 5 shows a flow diagram for predicted responses to a non-stimulant (i.e., atomoxetine) using informative occurrences associated with DRD4 and NET1, as well as a predicted dosing regimen for atomoxetine using the informative occurrences associated with NET1.

FIG. 6 shows a sample report form for clinicians and other health professions which informs decisions based on genotypic analysis as described.

### DETAILED DESCRIPTION OF THE INVENTION

Before the present composition, methods, and methodologies are described, it is to be understood that this invention is not limited to particular compositions, methods, and experimental conditions described, as such compositions, methods, and conditions may vary. It is also to be understood that the terminology used herein is for purposes of describing particular embodiments only, and is not intended to be limiting, since the scope of the present invention will be limited only in the appended claims.

As used in this specification and the appended claims, the singular forms “a”, “an”, and “the” include plural references unless the context clearly dictates otherwise. Thus, for example, references to “a nucleic acid” includes one or more nucleic acids, and/or compositions of the type described herein which will become apparent to those persons skilled in the art upon reading this disclosure and so forth.

Unless defined otherwise, all technical and scientific terms used herein have the same meaning as commonly understood by one of ordinary skill in the art to which this invention belongs. Any methods and materials similar or equivalent to those described herein can be used in the practice or testing of the invention, as it will be understood that modifications and variations are encompassed within the spirit and scope of the instant disclosure.

A “patient” or “subject” to be treated by the method of the invention can mean either a human or non-human animal, preferably a mammal.

The term “transcriptional regulator” refers to a biochemical element that acts to prevent or inhibit the transcription of a promoter-driven DNA sequence under certain environmental conditions (e.g., a repressor or nuclear inhibitory protein), or to permit or stimulate the transcription of the promoter-driven DNA sequence under certain environmental conditions (e.g., an inducer or an enhancer).

As used herein, the term “increased expression” refers to the level of a gene expression product is made higher and/or the activity of the gene expression product is enhanced. In embodiments, the increase is by at least 1.5-fold, the increase is at least 2-fold, 5-fold, or 10-fold, or the increase is at least 20-fold, relative to a control.

As used herein, the term “decreased expression” refers to the level of a gene expression product is made lower and/or the activity of the gene expression product is lowered. In embodiments, the decrease is at least 25%, the decrease is at least 50%, 60%, 70%, 80%, or 90% or the decrease is at least one-fold, relative to a control.

As used herein “correlates”, including grammatical variations thereof, means a phenomenon that accompanies another phenomenon, and is associated with it. For example, but not limited to, in embodiments, VNTR polymorphism occurrences comprising 9 or 10 repeats in the 3′ untranslated region of hSLC6A3 (DAT1); 7 repeats in exon 3 of hDRD4; 4 repeats 18.5 kb upstream of the hDRD5 (NC_{—}000004.11), where SNPs occurrences in a G allele in the 5′ untranslated region of the HhaI RFLP of hADRA2A; a VAL/VAL alleles at amino acid 158 of said hCOMT, where the subject is hyperactive or inattentive; and/or T/T alleles at the 3′ untranslated region of hSNAP-25 (rs3746544) is a phenomenon which accompanies (i.e., correlates with) ADHD.

The term “gene” refers to a DNA sequence in a chromosome that codes for a product (either RNA or its translation product, a polypeptide). A gene contains a coding region and includes regions preceding and following the coding region (termed respectively “leader” and “trailer”). The coding region is comprised of a plurality of coding segments (“exons”) and intervening sequences (“introns”) between individual coding segments.

As used herein, the term “gene expression profile” refers to the level or amount of gene expression of particular genes, for example, informative genes, as assessed by methods described herein. The gene expression profile may comprise data for one or more informative occurrences and can be measured at a single time point or over a period of time. For example, the gene expression profile may be determined using a single informative occurrence, or it can be determined using two or more informative occurrences, three or more informative occurrences, five or more informative occurrences, ten or more informative occurrences, twenty-five or more informative occurrences, or fifty or more informative occurrences. Phenotype classification (e.g., the presence or absence of a disease or disorder) can be made by comparing the gene expression profile of the sample with respect to one or more informative genes with one or more gene expression profiles (e.g., in a database). Using the methods described herein, expression of numerous genes can be measured simultaneously. The assessment of numerous genes provides for a more accurate evaluation of the sample because there are more genes that can assist in classifying the sample. A gene expression profile may involve only those genes that are increased in expression in a sample, only those genes that are decreased in expression in a sample, or a combination of genes that are increased and decreased in expression in a sample.

The terms “microarray,” “GeneChip,” “genome chip,” “DNA chip,” and “biochip,” as used herein refer to an ordered arrangement of hybridizeable array elements. The array elements are arranged so that there are preferably at least one or more different array elements on a substrate surface, such as paper, nylon or other type of membrane, filter, chip, glass slide, or any other suitable solid support. The hybridization signal from each of the array elements is individually distinguishable.

As generally known in the art, a variety of arrays can be used for detection of polymorphisms that can be correlated to the phenotypes of interest. In embodiments, DNA probe array chips or larger DNA probe array wafers (from which individual chips would otherwise be obtained by breaking up the wafer) may be used. In one embodiment, DNA probe array wafers may comprise glass wafers on which high density arrays of DNA probes (short segments of DNA) have been placed. Each of these wafers can hold, for example, millions of DNA probes that are used to recognize sample DNA sequences (e.g., from individuals or populations that may comprise polymorphisms of interest). The recognition of sample DNA by the set of DNA probes on the glass wafer takes place through DNA hybridization. When a DNA sample hybridizes with an array of DNA probes, the sample binds to those probes that are complementary to the sample DNA sequence. By evaluating to which probes the sample DNA for an individual hybridizes more strongly, it is possible to determine whether a known sequence of nucleic acid is present or not in the sample, thereby determining whether a polymorphism found in the nucleic acid is present.

In embodiments, the use of DNA probe arrays to obtain allele information typically involves the following general steps: design and manufacture of DNA probe arrays, preparation of the sample, hybridization of sample DNA to the array, detection of hybridization events, and data analysis to determine sequence. In one embodiment, wafers may be manufactured using a process adapted from semiconductor manufacturing to achieve cost effectiveness and high quality, and are available, e.g., from Affymetrix, Inc. of Santa Clara, Calif.

Genomic DNA may be hybridized to an array, including for example, the Affymetrix Genome-Wide human SNP Array 6.0, according to the manufacturer's protocol. Following scanning, arrays may be checked for quality using, for example, Affymetrix Genotyping Consoles. Further, data may be analyzed by various algorithms for clustering, call confidence, Mendelian concordance, power calculation, to perform multifiltering, linkage disequilibrium, and the like. Such algorithms include, but are not limited to, Bayesian Robust Linear Model with Mahalanobis Distance Classifier, Corrected Robust Linear Model with Maximum Likelihood Classification, Birdsuite, PennCNV (with GC model adjustment), and the like or combinations thereof.

The terms “complementary” or “complementarity” as used herein refer to polynucleotides (i.e., a sequence of nucleotides) related by the base-pairing rules. For example, for the sequence “A-G-T,” is complementary to the sequence “T-C-A.” Complementarity may be “partial,” in which only some of the nucleic acids' bases are matched according to the base pairing rules. Or, there may be “complete” or “total” complementarity between the nucleic acids. The degree of complementarity between nucleic acid strands has significant effects on the efficiency and strength of hybridization between nucleic acid strands. This is of particular importance in amplification reactions, as well as detection methods which depend upon binding between nucleic acids.

As used herein, the term “hybridization” is used in reference to the pairing of complementary nucleic acids. Hybridization and the strength of hybridization (i.e., the strength of the association between the nucleic acids) is impacted by such factors as the degree of complementary between the nucleic acids, stringency of the conditions involved, the Tₘ of the formed hybrid complexes, and the G:C ratio within the nucleic acids.

As used herein, the term “primer” refers to an oligonucleotide, whether occurring naturally as in a purified restriction digest or produced synthetically, which is capable of acting as a point of initiation of synthesis when placed under conditions in which synthesis of a primer extension product which is complementary to a nucleic acid strand is induced, (i.e., in the presence of nucleotides and an inducing agent such as DNA polymerase and at a suitable temperature and pH). The primer is preferably single stranded for maximum efficiency in amplification, but may alternatively be double stranded. If double stranded, the primer is first treated to separate its strands before being used to prepare extension products. In embodiments, the primer is an oligodeoxyribonucleotide. The primer must be sufficiently long to prime the synthesis of extension products in the presence of the inducing agent. The exact lengths of the primers will depend on many factors, including temperature, source of primer and the use of the method.

As used herein, the term “probe” refers to an oligonucleotide (i.e., a sequence of nucleotides), whether occurring naturally as in a purified restriction digest or produced synthetically, recombinantly or by PCR amplification, which is capable of hybridizing to another oligonucleotide of interest. A probe may be single-stranded or double-stranded. Probes are useful in the detection, identification and isolation of particular gene sequences. It is contemplated that any probe used in the present invention will be labeled with any “reporter molecule,” so that is detectable in any detection system, including, but not limited to enzyme (e.g., ELISA, as well as enzyme-based histochemical assays), fluorescent, radioactive, and luminescent systems. It is not intended that the present disclosure be limited to any particular detection system or label.

As used herein, the terms “compound” and “test compound” refer to any chemical entity, pharmaceutical, drug, and the like that can be used to treat or prevent a disease, illness, conditions, or disorder of bodily function. Compounds comprise both known and potential therapeutic compounds. A compound can be determined to be therapeutic by screening using the screening methods of the present invention. A “known therapeutic compound” or “medicament” refers to a therapeutic compound that has been shown (e.g., through animal trials or prior experience with administration to humans) to be effective in such treatment. Examples of test compounds include, but are not limited to peptides, polypeptides, synthetic organic molecules, naturally occurring organic molecules, nucleic acid molecules, and combinations thereof.

For example, such therapeutic compounds or medicaments may include, but are not limited to, amiodarone, diisopyramide, verapamil, propranolol, amlodipine, clonidine, diltiazem, felodipine, guanabenz acetate, isradipine, minoxidil, chloride nicardipine, nifedipine, chloride prazosin, papaverine, carbamazepine, decarbazine, etoposide, lomustine, melphalan, mitomicin, mitoanthrone, procarbazine, taxol and derivatives thereof, alprazolam, bromazepam, diazepam, lorazepam, oxazepam, temazepam, sulpiride, triazolam, alprenolol, atenolol, oxprenolol, pindolol, propranolol, salbutamol, salmeterol, aminone, digitoxinn, digoxin, lanatoside C, medigoxine, aclacinomycins, actinomycins, adriamycins, ancitabines, anthramycins, azacitidines, azaserines, 6-azauridines, bisantrenes, bleomycins, cactinomycins, carmofurs, carmustines, carubicins, carzinophilins, chromomycins, cisplatins, cladribines, cytarabines, dactinomycins, daunorubicins, denopterins, 6-diazo-5-oxo-L-norleucines, doxifluridines, doxorubicins, edatrexates, emitefurs, enocitabines, fepirubicins, fludarabines, fluorouracils, gemcitabines, idarubicins, loxuridines, menogarils, 6-mercaptopurines, methotrexates, mithramycins, mycophenolic acids, nogalamycins, olivomycines, peplomycins, pirarubicins, piritrexims, plicamycins, porfiromycins, pteropterins, puromycins, retinoic acids, streptonigrins, streptozocins, tagafurs, tamoxifens, thiamiprines, thioguanines, triamcinolones, trimetrexates, tubercidins, vinblastines, vincristines, zinostatins, zorubicins, fluoxetine, aripiprazole, clozapine, iloperidone, fluphenazine, ziprasidone, haloperidol, paliperidone, loxapine, molindone, thiothixene, pimozide, perphenazine, risperidone, quetiapine, trifluoperazine, thioridazine, chlorpromazine, olanzapine, clomipramine, amoxapine, nortriptyline, citalopram, duloxetine, trazodone, venlafaxine, amitriptyline, selegiline, escitalopram, maprotiline, fluvoxamine, isocarboxazid, phenelzine, desipramine, tranylcypromine, paroxetine, paroxetine-mesylate, desvenlafaxine, mirtazapine, doxepin, trimipramine, imipramine, imipramine pamoate, protriptyline, bupropion, sertraline, divalproex sodium, lithium carbonate, lamotrigine, lithium citrate, lithium carbonate, gabapentin, carbamazepine, topiramate, oxcarbazepine, lorazepam, buspirone, clonazepam, chlordiazepoxide, oxazepam, clorazepate, diazepam, alprazolam, amphetamine, methylphenidate, methamphetamine, dextroamphetamine, dextroamphetamine, dexmethylphenidate, guanfacine, atomoxetine, lisdexamfetamine and dimesylate.

A “sample” from a subject may include a single cell or multiple cells or fragments of cells or an aliquot of body fluid, taken from the subject, by means including venipuncture, excretion, ejaculation, massage, biopsy, needle aspirate, lavage sample, scraping (buccal), surgical incision or intervention or other means known in the art.

As used herein, the term “subject” refers to a cell, tissue, or organism, human or non-human, whether in vivo, ex vivo or in vitro, under observation.

As used herein, the term “informative occurrence” refers to the observation of a repeat or allele in an analyzed genotype whose detection correlates with a particular phenotype, such as the presence or absence of a psychiatric condition in an individual or whether a test compound or treatment is predicted to be efficacious. Samples can be classified according to their broad genotypic profile, or according to the presence or absence of particular informative occurrences. The repeats or detection of alleles that are relevant for classification are referred to herein as “informative occurrences.” Not all informative occurrences for a particular class or phenotype distinction must be assessed in order to classify a sample. Similarly, the set of informative occurrences that characterize one phenotypic effect may or may not be the same as the set of informative occurrences for a different phenotypic effect. Typically the accuracy of the classification increases with the number of informative occurrences that are assessed.

The terms “disorders” and “diseases” are used inclusively and refer to any deviation from the normal structure or function of any part, organ or system of the body (or any combination thereof). For example, disorders and diseases include, but are not limited to, behavioral health/emotional-behavioral disorders such as ADHD, autism, depression, schizophrenia, bipolar disorder, Alzheimer's, and the like; cardiovascular diseases or disorders such as hypertension, arthrosclerosis, high cholesterol, heart disease, and the like; cancers such as endometrial cancer, ovarian cancer, breast cancer, lung cancer, colon cancer, prostate cancer, and the like. A specific disease is manifested by characteristic symptoms and signs, including biological, chemical and physical changes, and is often associated with a variety of other factors including, but not limited to, demographic, environmental, employment, genetic and medically historical factors. Certain characteristic signs, symptoms, and related factors can be quantitated through a variety of methods to yield important diagnostic information.

The term “mood” is used herein to mean an individual's enduring emotional state, while “affect” refers to short-term fluctuations in emotional state. Thus, the term “mood disorder” is used in reference to conditions in which abnormalities of emotional state are the core symptoms. The most common serious mood disorders reportedly seen in general medical practice are major depression (unipolar depression), dysthymic disorder (chronic, milder form of depression), and bipolar disorder (manic-depressive illness).

The term “psychiatric condition” or “psychiatric disorder” is used herein to mean mental, emotional, or behavioral abnormalities. These include but are not limited to bipolar disorder, schizophrenia, schizoaffective disorder, psychosis, depression, stimulant abuse, alcoholism, panic disorder, generalized anxiety disorder, attention deficit/hyperactivity disorder, post-traumatic stress disorder, and Parkinson's disease.

Although clinical literature suggests all patients may respond equally to any one given medication, individual response often varies. Some of these responses are reflected by increased costs, prolonged hospitalizations, adverse drug reactions, or no response to medication. Annually, 100 billion dollars are spent on patients who have experienced an adverse drug response. These variations in physiological response to medications may be associated with specific gene variants called variable number tandem repeats (VNTRs) and single-nucleotide polymorphisms (SNPs).

Current knowledge of how these variations occur includes genetic differences in drug metabolizing enzymes, drug transporters and drug targets. In embodiments, the distinction of enzymes and transporters as an adjunct to medication utilization review and traditional clinical care using, for example, the Affymetrix, Inc. DMET (drug metabolism enzymes and transporters) system, is disclosed.

When a drug is metabolized in the body, it goes through phase I or phase II reactions to either activate or deactivate a medication. Absorption, distribution, metabolism and excretion enzymes in phase I reactions are mediated by the CYP family of enzymes and normally occur in the liver. Phase II reactions add a substrate to the medication and cause it to be eliminated by the bile or urine. Any genetic variance to these enzymatic processes may cause a patient to become “toxic,” a “fast metabolizer,” or “poor metabolizer.”

Platforms have been developed to analyze genetic variants and have been approved by the FDA for use in psychiatric illnesses. One existing platform looks at polymorphisms of CYP2D6 and CYP2C19. Along with these platforms exists others that identify still other genes.

In embodiments, a method of predicting responsiveness to treatment of disorder or disease with a medicament is disclosed including (a) obtaining a sample of body fluid or other tissue from said subject, (b) isolating DNA from said samples and applying the DNA under hybridization conditions to a solid phase containing a plurality of select genes, (b) determining informative occurrences of one or more variable number of tandem repeat (VNTR) polymorphisms present in select genes in said subject's sample and (c) determining informative occurrences of one or more single nucleotide polymorphisms (SNPs) present in select genes in said subject's sample, wherein said occurrences of said one or more VNTR polymorphisms and said one or more SNPs in said sample correlates with said subject's response to treatment with said compound or pharmaceutically acceptable salt thereof.

In other embodiments, a method is disclosed for predicting responsiveness to treatment of attention-deficit/hyperactivity disorder (ADHD) in a subject susceptible to developing ADHD with a compound including, but not limited to, methylphenidate, amphetamine, atomoxetine, and bupropion, or a pharmaceutically acceptable salt thereof, including obtaining a sample of body fluid or other tissue from said subject, determining informative occurrences of variable number of tandem repeat (VNTR) polymorphisms present in genes selected from the group consisting of human dopamine transporter 1 (hDAT1; NM_{—}001044.4), human dopamine receptor D4 (hDRD4; DQ846850.1), human dopamine receptor D5 (hDRD5), human serotonin transporter promoter region (h5-HTTLPR) and combinations thereof, and determining informative occurrences of one or more single nucleotide polymorphisms (SNPs) including, but not limited to, hCOMT (rs4680); hSNAP-25 (rs3746544); hNET (rs998424); hNET (rs3785157); hNET (rs47958); hSLC6A2 (rs47958, rs36017, and rs2270935); hSERT (rs25331); hADRA2A (rs1800545) and combinations thereof, in the subject's sample, where the occurrences of the one or more VNTR polymorphisms and the one or more SNPs in the sample are predictive of the subject's response to treatment with the compound or pharmaceutically acceptable salt thereof.

In embodiments, the methods disclosed herein may include assaying the presence of one or more polymorphisms in an individual which may include methods generally known in the art. In one embodiment, methods for assaying a genetic polymorphism in an individual may include assaying an individual for the presence of or the absence of a SNP associated with ADHD using one or more genotyping assays such as a SNP array, PCR-based SNP genotyping, DNA hybridization, fluorescence microscopy, and other methods known by those of skill in the art.

Samples that are suitable for use in the methods described herein contain genetic material, e.g., genomic DNA (gDNA). Genomic DNA is typically extracted from biological samples such as blood or mucosal scrapings of the lining of the mouth, but can be extracted from other biological samples including urine or expectorant. The sample itself will typically consist of nucleated cells (e.g., blood or buccal cells) or tissue removed from the subject. The subject can be an adult, child, fetus, or embryo. In some embodiments, the sample is obtained prenatally, either from a fetus or embryo or from the mother (e.g., from fetal or embryonic cells in the maternal circulation). Methods and reagents are known in the art for obtaining, processing, and analyzing samples. In some embodiments, the sample is obtained with the assistance of a health care provider, e.g., to draw blood. In some embodiments, the sample is obtained without the assistance of a health care provider, e.g., where the sample is obtained non-invasively, such as a sample comprising buccal cells that is obtained using a buccal swab or brush, or a mouthwash sample.

In some cases, a biological sample may be processed for DNA isolation. For example, DNA in a cell or tissue sample can be separated from other components of the sample. Cells can be harvested from a biological sample using standard techniques known in the art. For example, cells can be harvested by centrifuging a cell sample and resuspending the pelleted cells. The cells can be resuspended in a buffered solution such as phosphate-buffered saline (PBS). After centrifuging the cell suspension to obtain a cell pellet, the cells can be lysed to extract DNA, e.g., gDNA. The sample can be concentrated and/or purified to isolate DNA. All samples obtained from a subject, including those subjected to any sort of further processing, are considered to be obtained from the subject. Routine methods can be used to extract genomic DNA from a biological sample, including, for example, phenol extraction. Alternatively, genomic DNA can be extracted with kits such as the QIAAMP Tissue Kit (Qiagen, Chatsworth, Calif.) and the WIZARD Genomic DNA purification kit (Promega). Non-limiting examples of sources of samples include urine, blood, and tissue.

Other methods of nucleic acid analysis can include direct manual sequencing (Church and Gilbert, Proc. Natl. Acad. Sci. USA 81:1991-1995 (1988); Sanger et al., Proc. Natl. Acad. Sci. USA 74:5463-5467 (1977); Beavis et al., U.S. Pat. No. 5,288,644); automated fluorescent sequencing; single-stranded conformation polymorphism assays (SSCP) (Schafer et al., Nat. Biotechnol 15:33-39 (1995)); clamped denaturing gel electrophoresis (CDGE); two-dimensional gel electrophoresis (2DGE or TDGE); conformational sensitive gel electrophoresis (CSGE); denaturing gradient gel electrophoresis (DGGE) (Sheffield et al., Proc. Natl. Acad. Sci. USA 86:232-236 (1989)); denaturing high performance liquid chromatography (DHPLC, Underhill et al., Genome Res. 7:996-1005 (1997)); infrared matrix-assisted laser desorption/ionization (IR-MALDI) mass spectrometry (WO 99/57318); mobility shift analysis (Orita et al., Proc. Natl. Acad. Sci. USA 86:2766-2770 (1989)); restriction enzyme analysis (Flavell et al., Cell 15:25 (1978); Geever et al., Proc. Natl. Acad. Sci. USA 78:5081 (1981)); quantitative real-time PCR (Raca et al., Genet Test 8(4):387-94 (2004)); heteroduplex analysis; chemical mismatch cleavage (CMC) (Cotton et al., Proc. Natl. Acad. Sci. USA 85:4397-4401 (1985)); RNase protection assays (Myers et al., Science 230:1242 (1985)); use of polypeptides that recognize nucleotide mismatches, e.g., E. coli mutS protein; allele-specific PCR, and combinations of such methods. See, e.g., Gerber et al., U.S. Patent Publication No. 2004/0014095 which is incorporated herein by reference in its entirety.

Sequence analysis can also be used to detect specific polymorphic variants. For example, polymorphic variants can be detected by sequencing exons, introns, 5′ untranslated sequences, or 3′ untranslated sequences. A sample comprising DNA or RNA is obtained from the subject. PCR or other appropriate methods can be used to amplify a portion encompassing the polymorphic site, if desired. The sequence is then ascertained, using any standard method, and the presence of a polymorphic variant is determined. Real-time pyrophosphate DNA sequencing is yet another approach to detection of polymorphisms and polymorphic variants (Alderborn et al., Genome Research 10(8):1249-1258 (2000)). Additional methods include, for example, PCR amplification in combination with denaturing high performance liquid chromatography (dHPLC) (Underhill et al., Genome Research 7(10):996-1005 (1997)).

In order to detect polymorphisms and/or polymorphic variants, it will frequently be desirable to amplify a portion of genomic DNA (gDNA) encompassing the polymorphic site. Such regions can be amplified and isolated by PCR using oligonucleotide primers designed based on genomic and/or cDNA sequences that flank the site. PCR refers to procedures in which target nucleic acid (e.g., genomic DNA) is amplified in a manner similar to that described in U.S. Pat. No. 4,683,195, and subsequent modifications of the procedure described therein. Generally, sequence information from the ends of the region of interest or beyond are used to design oligonucleotide primers that are identical or similar in sequence to opposite strands of a potential template to be amplified. See e.g., PCR Primer: A Laboratory Manual, Dieffenbach and Dveksler, (Eds.); McPherson et al., PCR Basics: From Background to Bench (Springer Verlag, 2000); Mattila et al., Nucleic Acids Res., 19:4967 (1991); Eckert et al., PCR Methods and Applications, 1:17 (1991); PCR (eds. McPherson et al., Press, Oxford); and U.S. Pat. No. 4,683,202. Other amplification methods that may be employed include the ligase chain reaction (LCR) (Wu and Wallace, Genomics 4:560 (1989), Landegren et al., Science 241:1077 (1988), transcription amplification (Kwoh et al., Proc. Natl. Acad. Sci. USA 86:1173 (1989)), self-sustained sequence replication (Guatelli et al., Proc. Nat. Acad. Sci. USA 87:1874 (1990)), and nucleic acid based sequence amplification (NASBA). Guidelines for selecting primers for PCR amplification are well known in the art. See, e.g., McPherson et al., PCR Basics: From Background to Bench, Springer-Verlag, 2000. A variety of computer programs for designing primers are available, e.g., ‘Oligo’ (National Biosciences, Inc, Plymouth Minn.), MacVector (Kodak/IBI), and the GCG suite of sequence analysis programs (Genetics Computer Group, Madison, Wis. 53711).

In some cases, PCR conditions and primers can be developed that amplify a product only when the variant allele is present or only when the wild type allele is present (MSPCR or allele-specific PCR). For example, patient DNA and a control can be amplified separately using either a wild type primer or a primer specific for the variant allele. Each set of reactions is then examined for the presence of amplification products using standard methods to visualize the DNA. For example, the reactions can be electrophoresed through an agarose gel and the DNA visualized by staining with ethidium bromide or other DNA intercalating dye. In DNA samples from heterozygous patients, reaction products would be detected in each reaction.

Real-time quantitative PCR can also be used to determine copy number. Quantitative PCR permits both detection and quantification of specific DNA sequence in a sample as an absolute number of copies or as a relative amount when normalized to DNA input or other normalizing genes. A key feature of quantitative PCR is that the amplified DNA product is quantified in real-time as it accumulates in the reaction after each amplification cycle. Methods of quantification can include the use of fluorescent dyes that intercalate with double-stranded DNA, and modified DNA oligonucleotide probes that fluoresce when hybridized with a complementary DNA. Methods of quantification can include determining the intensity of fluorescence for fluorescently tagged molecular probes attached to a solid surface such as a microarray.

Fluorophores of different colors can be chosen such that each probe in a set can be distinctly visualized. For example, a combination of the following fluorophores can be used: 7-amino-4-methylcoumarin-3-acetic acid (AMCA), TEXAS RED™ (Molecular Probes, Inc., Eugene, Oreg.), 5-(and -6)-carboxy-X-rhodamine, lissamine rhodamine B, 5-(and -6)-carboxyfluorescein, fluorescein-5-isothiocyanate (FITC), 7-diethylaminocoumarin-3-carboxylic acid, tetramethylrhodamine-5-(and -6)-isothiocyanate, 5-(and -6)-carboxytetramethylrhodamine, 7-hydroxycoumarin-3-carboxylic acid, 6-[fluorescein 5-(and -6)-carboxamido]hexanoic acid, N-(4,4-difluoro-5,7-dimethyl-4-bora-3a,4a diaza-3-indacenepropionic acid, eosin-5-isothiocyanate, erythrosin-5-isothiocyanate, and CASCADE blue acetylazide (Molecular Probes, Inc., Eugene, Oreg.). Fluorescently labeled probes can be viewed with a fluorescence microscope and an appropriate filter for each fluorophore, or by using dual or triple band-pass filter sets to observe multiple fluorophores. See, for example, U.S. Pat. No. 5,776,688. Alternatively, techniques such as flow cytometry can be used to examine the hybridization pattern of the probes. Fluorescence-based arrays are also known in the art.

In other embodiments, the probes can be indirectly labeled with, e.g., biotin or digoxygenin, or labeled with radioactive isotopes such as ³²P and ³H. For example, a probe indirectly labeled with biotin can be detected by avidin conjugated to a detectable marker. For example, avidin can be conjugated to an enzymatic marker such as alkaline phosphatase or horseradish peroxidase. Enzymatic markers can be detected in standard colorimetric reactions using a substrate and/or a catalyst for the enzyme. Catalysts for alkaline phosphatase include 5-bromo-4-chloro-3-indolylphosphate and nitro blue tetrazolium. Diaminobenzoate can be used as a catalyst for horseradish peroxidase.

Generally, microarray hybridization is performed by hybridizing a nucleic acid of interest (e.g., a nucleic acid encompassing a polymorphic site) with the array and detecting hybridization using nucleic acid probes. In some cases, the nucleic acid of interest is amplified prior to hybridization. Hybridization and detecting are generally carried out according to standard methods. See, e.g., Published PCT Application Nos. WO 92/10092 and WO 95/11995, and U.S. Pat. No. 5,424,186. For example, the array can be scanned to determine the position on the array to which the nucleic acid hybridizes. The hybridization data obtained from the scan is typically in the form of fluorescence intensities as a function of location on the array.

Arrays can be formed on substrates fabricated with materials such as paper, glass, plastic (e.g., polypropylene, nylon, or polystyrene), polyacrylamide, nitrocellulose, silicon, optical fiber, or any other suitable solid or semisolid support, and can be configured in a planar (e.g., glass plates, silicon chips) or three dimensional (e.g., pins, fibers, beads, particles, microtiter wells, capillaries) configuration. Methods for generating arrays are known in the art and include, e.g., photolithographic methods (see, e.g., U.S. Pat. Nos. 5,143,854; 5,510,270; and 5,527,681), mechanical methods (e.g., directed-flow methods as described in U.S. Pat. No. 5,384,261), pin-based methods (e.g., as described in U.S. Pat. No. 5,288,514), and bead-based techniques (e.g., as described in PCT US/93/04145). The array typically includes oligonucleotide hybridization probes capable of specifically hybridizing to different polymorphic variants. Oligonucleotide probes that exhibit differential or selective binding to polymorphic sites may readily be designed by one of ordinary skill in the art. For example, oligonucleotide that is perfectly complementary to a sequence that encompasses a polymorphic site (i.e., a sequence that includes the polymorphic site, within it or at one end) will generally hybridize preferentially to a nucleic acid comprising that sequence, as opposed to a nucleic acid comprising an alternate polymorphic variant.

Oligonucleotide probes forming an array may be attached to a substrate by any number of techniques, including, without limitation, (i) in situ synthesis (e.g., high-density oligonucleotide arrays) using photolithographic techniques; (ii) spotting/printing at medium to low density on glass, nylon or nitrocellulose; (iii) by masking, and (iv) by dot-blotting on a nylon or nitrocellulose hybridization membrane. Oligonucleotides can be immobilized via a linker, including by covalent, ionic, or physical linkage. Linkers for immobilizing nucleic acids and polypeptides, including reversible or cleavable linkers, are known in the art. See, for example, U.S. Pat. No. 5,451,683 and WO98/20019. Alternatively, oligonucleotides can be non-covalently immobilized on a substrate by hybridization to anchors, by means of magnetic beads, or in a fluid phase such as in microtiter wells or capillaries. Immobilized oligonucleotide probes are typically about 20 nucleotides in length, but can vary from about 10 nucleotides to about 1000 nucleotides in length.

In some aspects, the methods described herein can include using an array that can ascertain differential expression patterns or copy numbers of one or more genes in samples from normal and affected individuals (see, e.g., Redon et al., Nature 444(7118):444-54 (2006)). For example, arrays of probes to a marker described herein can be used to measure polymorphisms between DNA from a subject having ADHD, and control DNA, e.g., DNA obtained from an individual that does not have ADHD, and has no risk factors for ADHD. Since the clones on the array contain sequence tags, their positions on the array are accurately known relative to the genomic sequence. Different hybridization patterns between DNA from an individual afflicted with ADHD and DNA from a normal individual at areas in the array corresponding to markers as described herein, and, optionally, one or more other regions associated with AP, are indicative of a risk of ADHD. Methods for array production, hybridization, and analysis are described, e.g., in Snijders et al., Nat. Genetics 29:263-264 (2001); Klein et al., Proc. Natl. Acad. Sci. USA 96:4494-4499 (1999); Albertson et al., Breast cancer Research and Treatment 78:289-298 (2003); and Snijders et al., “BAC microarray based comparative genomic hybridization,” in: Zhao et al. (eds), Bacterial Artificial chromosomes: Methods and Protocols, Methods in Molecular Biology, Humana Press, 2002.

One of skill in the art will appreciate that alleles involving markers in LD with the polymorphisms described herein can also be used in a similar manner to those described herein. Methods of calculating LD are known in the art (see, e.g., Morton et al., Proc. Natl. Acad. Sci. USA 98(9):5217-21 (2001); Tapper et al., Proc. Natl. Acad. Sci. USA 102(33):11835-11839 (2005); Maniatis et al., Proc. Natl. Acad. Sci. USA 99:2228-2233 (2002)). Thus, in some cases, the methods can include analysis of polymorphisms that are in LD with a polymorphism described herein. Methods are known in the art for identifying such polymorphisms; for example, the International HapMap Project provides a public database that can be used, see hapmap.org, as well as The International HapMap Consortium, Nature 426:789-796 (2003), and The International HapMap Consortium, Nature 437:1299-1320 (2005). Generally, it will be desirable to use a HapMap constructed using data from individuals who share ethnicity with the subject. For example, a HapMap for African Americans would ideally be used to identify markers in LD with an exemplary marker described herein for use in genotyping a subject of African American descent.

### General Description of ADHD Disease

Children with attention deficit/hyperactivity disorder (ADHD) show signs of excessively high activity levels, restlessness, impulsivity and inattention. Children with ADHD have difficulties listening to instructions, organizing their work, finishing schoolwork or chores, engaging in tasks that require sustained mental effort, engaging in quiet activities, sitting still, or waiting their turn. These problems are present before the age of 7 years and, in most cases, diagnosis will be made when starting primary school.

There is no single definitive test for the diagnosis of ADHD. However, The American Psychiatric Association has set up a number of criteria for the diagnosis of ADHD (Diagnostic and Statistical Manual of Mental Disorders DSM-IV et DSM-IVR: American Psychiatric Association, 1994 and 2000). The disease can be subdivided into three different subtypes:

1. Attention-deficit/hyperactivity disorder, combined type.

2. Attention-deficit/hyperactivity disorder, predominantly inattentive type.

3. Attention-deficit/hyperactivity disorder, predominantly hyperactive-impulsive type.

Inattention:

a. often fails to give close attention to details or makes careless mistakes in schoolwork, work, or other activities;

b. often has difficulty sustaining attention in tasks or play activities;

c. often does not seem to listen when spoken to directly;

d. often does not follow through on instructions and fails to finish schoolwork, chores, or duties in the workplace (not due to oppositional behavior or failure to understand instructions);

e. often has difficulty organizing tasks and activities;

f. often avoids, dislikes, or is reluctant to engage in tasks that require sustained mental effort (such as schoolwork or homework);

g. often loses things necessary for tasks or activities (e.g., toys, school assignments, pencils, books, or tools);

h. is often easily distracted by extraneous stimuli;

i. is often forgetful in daily activities.

Hyperactivity:

a. often fidgets with hands or feet or squirms in seat;

b. often leaves seat in classroom or in other situations in which remaining seated is expected;

c. often runs about or climbs excessively in situations in which it is inappropriate (in adolescents or adults, may be limited to subjective feelings of restlessness);

d. often has difficulty playing or engaging in leisure activities quietly;

e. is often “on the go” or often acts as if “driven by a motor”;

f. often talks excessively.

Impulsivity:

a. often blurts out answers before questions have been completed;

b. often has difficulty awaiting turn;

c. often interrupts or intrudes on others (e.g., butts into conversations or games).

ADHD diagnosis is made only when the child shows either six (6) or more of the symptoms of inattention OR six (6) or more of the symptoms of hyperactivity-impulsivity or six (6) symptoms of each category for the combined type. Those symptoms have persisted for at least 6 months to a degree that is maladaptive and inconsistent with developmental level of a child that age.

ADHD incidence is observed more in boys than girls; the male-to-female ratios ranging from 3:1 and 9:1. However, girls seem to have the inattentive type of ADHD more often, and may thus not be properly diagnosed. Thus the discrepancy in ratios between the sexes may be because many girls are under-diagnosed. However, boys with the Predominantly Inattentive Type also tend to be under-diagnosed, so that argument alone cannot explain the gender difference.

ADHD symptoms can persist into adolescence and adulthood which results in difficulties in occupational, social and family lives. They have social difficulties, and they often end up engaging in antisocial activities such as drug and alcohol abuse, and criminal activities and drop out of school. They are also more prone to risk taking which makes them more susceptible to injuries. In addition, families with children with ADHD will often come under tremendous stress, including increased levels of parental frustration, and higher rates of divorce. Furthermore, and considering the familial incidence of the disorder, the parent may himself have to face problems related to ADHD. However, it has been suggested that up to 50% of the cases still suffer from disabling symptoms at age 20. ADHD might even be the most common undiagnosed psychiatric disorder in adults.

Neurophysiological studies of individuals with ADHD suggest that either the frontal cortex of the brain is dysfunctional, or there is some subcortical projection making it look as if the front is malfunctioning. Structural imaging studies of the brains of patients with ADHD have revealed damage to the brain, consistent with the fronto-subcortical classification. The fronto-subcortical systems which control attention and motor behavior are rich in catecholamines. This is of particular interest, since many of the pharmaceuticals used for treating ADHD interfere with the catecholamine balance.

Non-surgical treatment for active disease involves the use of stimulant drugs, i.e. methylphendiate (RITALIN®) and dextroamphetamine (DEXEDRINE®), where methylphendiate has been promoted more extensively by the drug industry, studied more often, and therefore are more widely prescribed. Both RITALIN® and DEXEDRINE® have similar side effects, and have been shown to be effective in children as well as in adults. No studies are available where children on medication have been followed into adulthood. Although drugs improve the abilities to do usual tasks in schoolwork, there has been no improvement in long-term academic achievement. Children who have other learning disabilities as well as ADHD may not respond so well to the stimulant drugs.

In embodiments, a method is disclosed for predicting responsiveness to treatment of attention-deficit/hyperactivity disorder (ADHD) in a subject susceptible to developing ADHD with a compound including, but not limited to, methylphenidate, amphetamine, atomoxetine, and bupropion, or a pharmaceutically acceptable salt thereof.

Any sample comprising cells or nucleic acids from patients or controls may be used. Preferred samples are those easily obtained from the patient or control. Such samples include, but are not limited to blood, peripheral lymphocytes, buccal swabs, epithelial cell swabs, nails, hair, bronchoalveolar lavage fluid, sputum, or other body fluid or tissue obtained from an individual.

In embodiments, DNA is extracted from such samples in the quantity and quality necessary to perform the method as describe using conventional DNA extraction and quantitation techniques.

In embodiments, assay-specific and/or locus-specific and/or allele-specific oligonucleotides for every VNTR or SNP marker are organized onto one or more arrays. The genotype for each VNTR and SNP locus may be revealed by hybridizing short PCR fragments comprising each SNP locus onto these arrays. The arrays permit a high-throughput genome wide association study using DNA samples from subjects as described. Such assay-specific and/or locus-specific and/or allele-specific oligonucleotides necessary for scoring each VNTR and SNP may be organized onto a solid support. Such supports may be arrayed on wafers, glass slides, beads or any other type of solid support.

In embodiments, the assay-specific and/or locus-specific and/or allele-specific oligonucleotides are not organized onto a solid support but are still used as a whole, in panels or one by one.

In embodiments, one or more VNTRs or portions of the SNP maps (publicly available maps and proprietary maps) are used to screen the whole genome, a subset of chromosomes, a chromosome, a subset of genomic regions or a single genomic region.

In embodiments, a method is disclosed for predicting responsiveness to treatment of mental disease or mood disorder in a subject susceptible to developing a metal disease or mood disorder with a compound including, but not limited to, an antipsychotic medicament, an antidepression medicament, an antianxiety medicament, a mood stabilizing medicament, an anticonvulsive medicament, an ADHD medicament, or a pharmaceutically acceptable salts thereof, including obtaining a sample of body fluid or other tissue from said subject, determining informative occurrences of one or more variable number of tandem repeat (VNTR) polymorphisms and determining informative occurrences of one or more single nucleotide polymorphisms (SNPs) in the subject's sample, where the occurrences of the one or more VNTR polymorphisms and the one or more SNPs in the sample are predictive of the subject's response to treatment with the compound or pharmaceutically acceptable salt thereof.

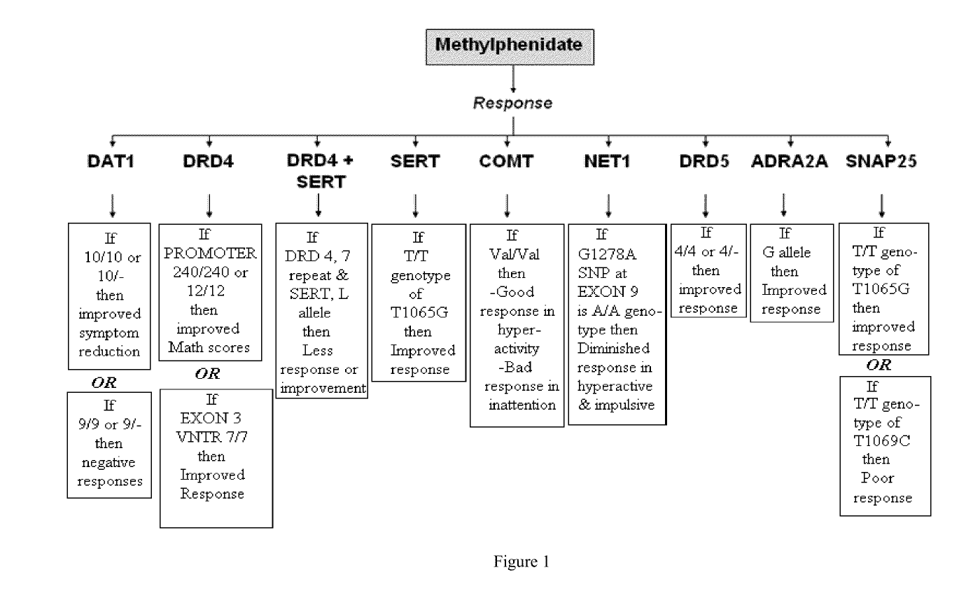

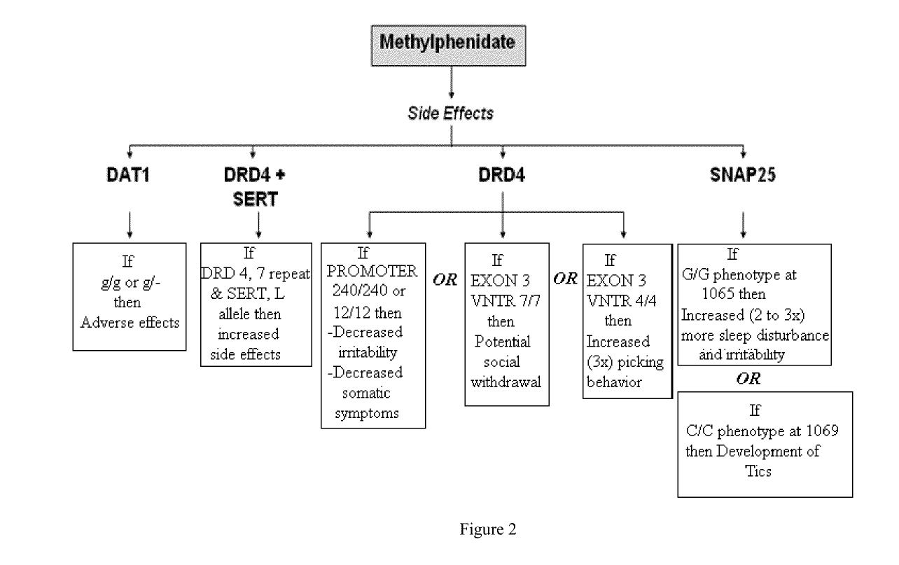

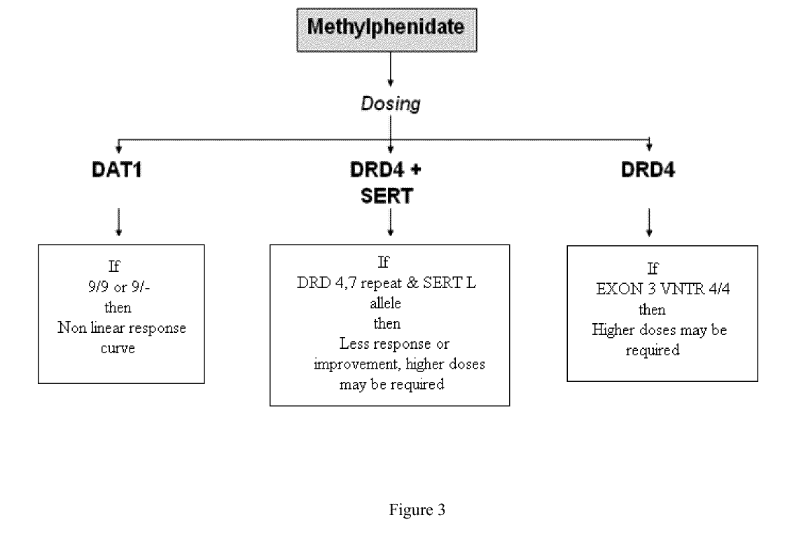

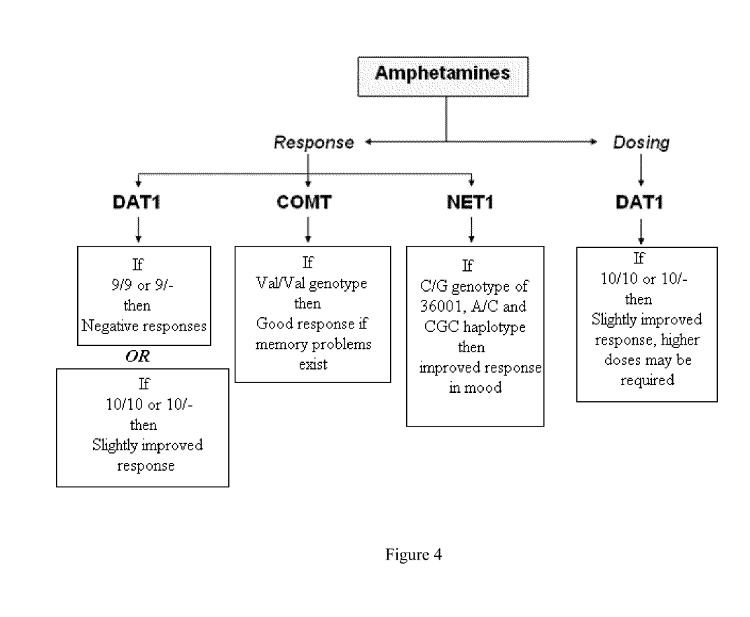

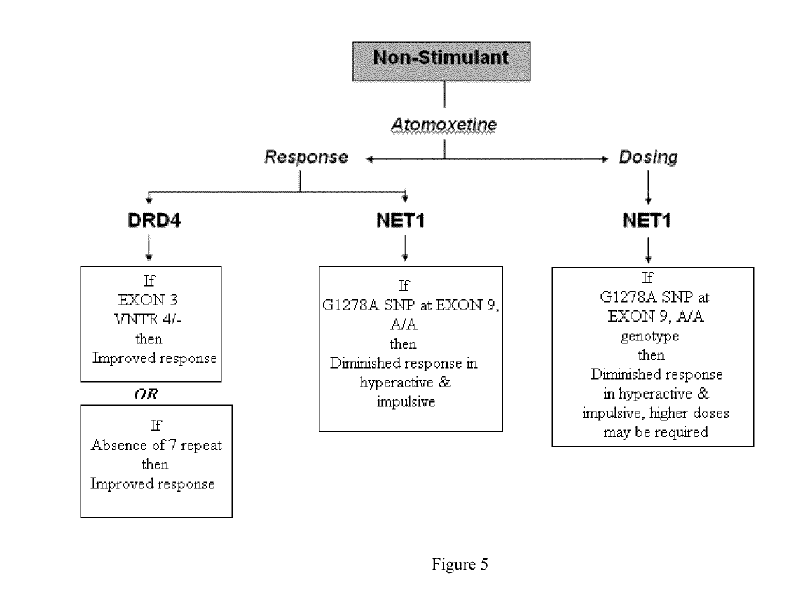

For example, FIGS. 1-5 provide flow diagrams for informative occurrences of polymorphisms for the genes as described herein with respect to ADHD, including predicted responses, side effects and dosage recommendations for various the described drugs.

In embodiments, a saliva sample is received in the lab and DNA is isolated. The isolated DNA is run through a combination of SNPs and VNTRs. The patient's genotype is then run through the algorithm that identifies whether the patient is more likely to metabolize or realize side effects associated with stimulants or non-stimulants. For example, algorithms may be used to analyze data using SAS version 9.1., including that descriptive statistics may be derived for demographic and genetic characteristics. Genotypes may be assessed for Hardy-Weinberg Equilibrium (HWE) using SAS PROC ALLELE. Predictors of efficacy may be tested using repeated measures ANOVA, fit using SAS PROC MIXED to account for any missing data. The fixed effects terms in each model may be, for example, gene dose and gene×dose interaction. Effect size estimates for efficacy may be based on, for example, Cohen's f², the ratio of variance explained to unexplained variance for the main and interactive effects. For side effects, generalized estimating equations based on logistic link functions may be conducted using SAS PROC GENMOD to access genotype contributions on binary outcomes.

Those of skill in the art will recognize that many of the functions and aspects of such a method may be implemented on a computer or computers. The hardware of such computer platforms typically is general purpose in nature, albeit with an appropriate network connection for communication via the intranet, the Internet and/or other data networks.

As known in the data processing and communications arts, each such general-purpose computer typically comprises a central processor, an internal communication bus, various types of memory (RAM, ROM, EEPROM, cache memory, etc.), disk drives or other code and data storage systems, and one or more network interface cards or ports for communication purposes. The computer system also may be coupled to a display and one or more user input devices such as alphanumeric and other keys of a keyboard, a mouse, a trackball, and the like. The display and user input element(s) together form a service-related user interface, for interactive control of the operation of the computer system. These user interface elements may be locally coupled to the computer system, for example in a workstation configuration, or the user interface elements may be remote from the computer and communicate therewith via a network. The elements of such a general-purpose computer system also may be combined with or built into routing elements or nodes of the network.

The software functionalities (e.g., many of the operations described above) involve programming of controllers, including executable code as well as associated stored data. The software code is executable by the general-purpose computer that functions as the particular computer. In operation, the executable program code and possibly the associated data are stored within the general-purpose computer platform. At other times, however, the software may be stored at other locations and/or transported for loading into the appropriate general-purpose computer system. Hence, the embodiments involve one or more software products in the form of one or more modules of code carried by at least one machine-readable medium. Execution of such code by a processor of the computer platform enables the platform to implement the system or platform functions, in essentially the manner performed in the embodiments discussed and illustrated herein.

As used herein, terms such as controller or CPU or computer or machine readable medium refer to any medium that participates in providing instructions to a processor for execution. Such a medium may take many forms, including but not limited to, non-volatile media, volatile media, and transmission media. Non-volatile media include, for example, optical or magnetic disks, such as any of the storage devices in any computer(s). Volatile media include dynamic memory, such as main memory of such a computer platform. Physical transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include, for example: a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

In embodiments, tests of each candidate gene may be considered independently, for example, it may be desired to minimize false positive findings and consideration of two primary measures may be desired, therefore a (Type I error rate) may be set at 2.5% based on a Bonferroni correction. Under such parameters, for example, side effects outcomes may remain at 5%. In certain aspects, the tests may be two tailed. In one aspect, the samples may be sufficiently powered to detect small gene and gene×dose effects at p<0.25 and medium effects at p<0.0005 based on Cohens'f².

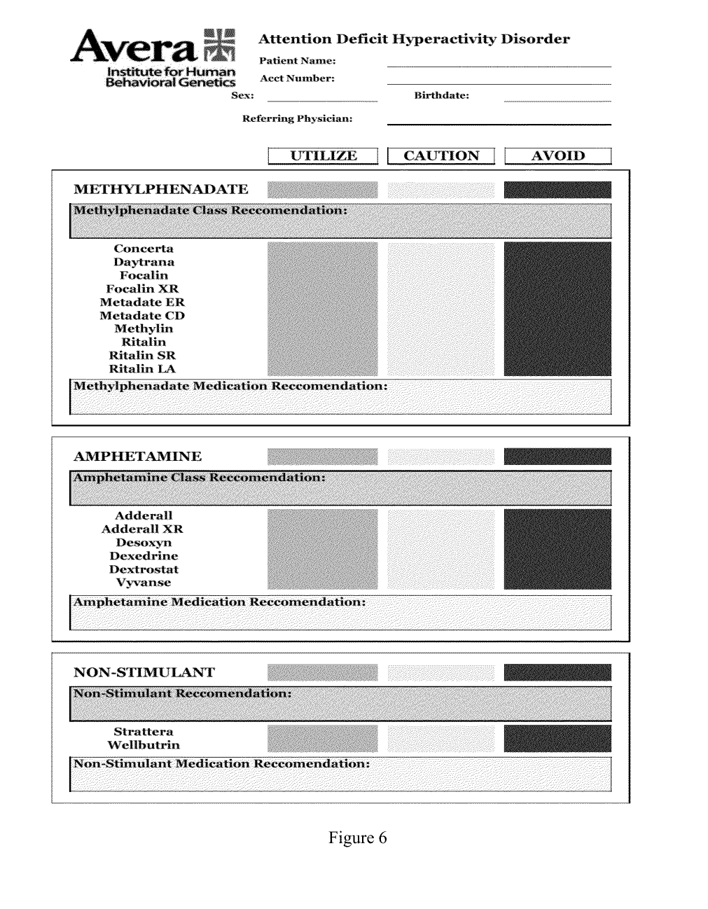

In embodiments, based on an individual's genotype of certain SNPs/VNTRs, the patient may be more responsive to a stimulant (methylphenidate or amphetamine) or non-stimulant medication. Additionally, also included with the stimulant medications, will potential side effects be experienced by the patient which may prevent them from taking it in the future. In embodiments, select medications within these appropriate drug classes may be identified. The information will then be packaged in a simplified report that will state based on the individual patient's genotype (see, e.g., FIG. 6):

1—If a Methylphenidate drug will work effectively for the patient or not and why. (Meds to use may be highlighted in medium grey, Med to use cautiously may be highlighted in light grey and Meds to avoid may be highlighted in dark grey to black).

2—If an Amphetamine drug will work effectively for the patient or not and why. (Meds to use may be highlighted in medium grey, Med to use cautiously may highlighted in light grey and Meds to avoid may be highlighted in dark grey to black).

3—If a non-stimulant drug will work effectively for the patient or not and why. (Meds to use may be highlighted in medium grey, Med to use cautiously may be highlighted in light grey and Meds to avoid may be highlighted in dark grey to black). In embodiments, light grey may be substituted by yellow, medium grey by green, and dark grey to black by red.

This information may be presented to the physician prior to initiating medication treatment to the patient. Upon review of the individualized report, the physician may use this information to make a more informed treatment decision based on the patient's genotype. This may eliminate a significant amount of trial-and-error that is experienced in treating ADHD other behavioral disorders and allow for more effective and expedited treatment.

The methods as disclosed may be carried out by employing a kit for the identification of a patient's polymorphism pattern at the VNTR or SNP locus polymorphic sites of the select genes as recited herein, comprising a instructions and reagents for determining the genetic polymorphism pattern at the VNTR or SNP sites. These reagents means may comprise oligo-nucleotides used to amplify a target region. Thus, the kit may contain, packaged in separate containers, a polymerase and a reaction buffer optimized for primer extension mediated by the polymerase, such as polymerase chain reaction (PCR). In addition to the materials as recited for determining a genetic polymorphism patterns, this kit may also include containers for collecting a body fluid sample, such as blood, and devices/reagents/instructions for obtaining genomic DNA from blood for the analysis. In embodiments, the nucleic acid is isolated from a biological sample taken from a subject, such as a blood or tissue sample. Suitable tissue samples include whole blood, semen, saliva, tears, urine, fecal material, sweat, buccal smears, skin, and biopsies of specific organ tissues, such as muscle or nerve tissue, and hair. The kit may comprise a container suitable for containing the needed materials and a sample of body fluid from the said subject, and instructions for use of the kit. These instructions would include the proper use of the kit and the proper manor of interpreting the results, as well as suggestions for patient selection or management depending on the specifics of the individual tested with the kit. Such instructions may include pamphlets, CDs, DVDs, and the like including URLs to obtain further information or guidance from the internet.

Unless otherwise explained, all technical and scientific terms used herein have the same meaning as commonly understood by one of ordinary skill in the art to which this disclosure belongs. Definitions of common terms in molecular biology can be found in The Merck Manual of Diagnosis and Therapy, 18th Edition, published by Merck Research Laboratories, 2006 (ISBN 0-911910-18-2); Robert S. Porter et al. (eds.), The Encyclopedia of Molecular Biology, published by Blackwell Science Ltd., 1994 (ISBN 0-632-02182-9); and Robert A. Meyers (ed.), Molecular Biology and Biotechnology: a Comprehensive Desk Reference, published by VCH Publishers, Inc., 1995 (ISBN 1-56081-569-8). Definitions of common terms in molecular biology may be found in Benjamin Lewin, Genes IX, published by Jones & Bartlett Publishing, 2007 (ISBN-13: 9780763740634); Kendrew et al. (eds.), The Encyclopedia of Molecular Biology, published by Blackwell Science Ltd., 1994 (ISBN 0-632-02182-9); and Robert A. Meyers (ed.), Molecular Biology and Biotechnology: a Comprehensive Desk Reference, published by VCH Publishers, Inc., 1995 (ISBN 1-56081-569-8).

Unless otherwise stated, the present invention was performed using standard procedures, as described, for example in Maniatis et al., Molecular Cloning: A Laboratory Manual, Cold Spring Harbor Laboratory Press, Cold Spring Harbor, N.Y., USA (1982); Sambrook et al., Molecular Cloning: A Laboratory Manual (2 ed.), Cold Spring Harbor Laboratory Press, Cold Spring Harbor, N.Y., USA (1989); Davis et al., Basic Methods in Molecular Biology, Elsevier Science Publishing, Inc., New York, USA (1986); or Methods in Enzymology: Guide to Molecular Cloning Techniques Vol. 152, S. L. Berger and A. R. Kimmerl (eds.), Academic Press Inc., San Diego, USA (1987)). Current Protocols in Molecular Biology (CPMB) (Fred M. Ausubel, et al. ed., John Wiley and Sons, Inc.), Current Protocols in Protein Science (CPPS) (John E. Coligan, et. al., ed., John Wiley and Sons, Inc.), Current Protocols in Immunology (CPI) (John E. Coligan, et. al., ed. John Wiley and Sons, Inc.), Current Protocols in Cell Biology (CPCB) (Juan S. Bonifacino et. al. ed., John Wiley and Sons, Inc.), Culture of Animal Cells: A Manual of Basic Technique by R. Ian Freshney, Publisher: Wiley-Liss; 5th edition (2005), Animal Cell Culture Methods (Methods in Cell Biology, Vol. 57, Jennie P. Mather and David Barnes editors, Academic Press, 1st edition, 1998) which are all incorporated by reference herein in their entireties.

The following examples are intended to illustrate but not limit the invention.

### Examples

### VNTR Genotyping Methods

Variable Number Tandem Repeat (VNTR) polymorphisms were genotyped in SERT (5-HTTLPR), DRD4 (48 bp tandem repeat in exon III), DAT1 (40 bp VNTR in the 3′ UTR), DRD5 (di-nucleotide repeat 18.5 kb upstream of transcription start site) and MAOA (30 bp tandem repeat in promoter) at the Avera Institute for Human Behavioral Genetics (AIHBG).

### SERT (5-HTTLPR)

5-HTTLPR and rs25331 was genotyped using restriction length fragment polymorphism (RFLP) with MspI. Primer sequences for 5-HTTLPR were previously described; forward primer (5′-6FAM-ATGCCAGCACCTAACCCCTAATGT-3′ SEQ ID NO:1) and the reverse primer (5′-GGACCGCAAGGTGGGCGGGA-3′ SEQ ID NO:2). This primer pair amplifies a 419 base pair product for the 16-repeat L allele and a 375 base pair product for the 14-repeat S allele. PCR reactions were performed using a PCR Master Mix (Promega, Madison, Wis., USA) containing a final concentration of 1.5 mM MgCl₂, 1× reaction buffer, 200 μM of each dNTP, 40 ng purified genomic DNA, 1.25 units Taq DNA polymerase, and 5 pmols of each primer in a 25 ul reaction. PCR cycling conditions consisted of an initial denaturation at 95° C. for 15 minutes, 35 cycles each consisting of 30 s at 94° C., 30 s at 66° C., and 40 s at 72° C. Elongation was continued for 15 min at 72° C. after the last cycle. To genotype the single nucleotide polymorphism (A/G) specific to the L allele, 10 ul of the PCR product was subjected to restriction fragment length polymorphism analysis (RFLP) with an MspI restriction digest. The LG polymorphism introduces an additional MspI restriction site within the PCR product. Fragments were separated on a 2% agarose gel supplemented with ethidium bromide (0.02%, Fisher, Pittsburgh, Pa., USA). The fragments used to discriminate each genotype are as follows (approximate sizes); S (290 base pairs), LA (320 base pairs), and LG (150 and 180 base pairs).

### DRD4 (48 bp Tandem Repeat in Exon III)

The 48 base pair VNTR in exon 3 of DRD4 (2-11 repeats) was genotyped using PCR and fragment analysis on a 3130 Genetic Analyzer (Applied Biosystems, Foster City, Calif., USA). The forward primer was fluorescently tagged with VIC (Applied Biosystems, Foster City, Calif., USA). The primer sequences were previously described: 5′-VIC-TGCTCTACTGGGCCACGTTC-3′ (SEQ ID NO:3) for the forward primer and 5′-TGCGGGTCTGCGGTGGAGTCT-3′ (SEQ ID NO:4) for the reverse primer. PCR reactions contained PCR Master Mix (Promega, Madison, Wis., USA) with a final concentration of 1.5 mM MgCl₂, 1× reaction buffer, 200 μM of each dNTP, 14 ng of purified genomic DNA, 1.25 U Taq DNA polymerase, 4 pmols of each primer and 1× Q solution (Qiagen, Valencia, Calif., USA) in a 10 μl reaction. PCR thermocycling conditions were as follows: initial denaturation for 10 mins at 98° C., 40 cycles of 1 min denaturation at 95° C., 30 s annealing at 58° C. and 1 min of extension at 72° C. An additional 10 minutes of extension at 72° C. followed before cooling to 4° C.

### DAT1 (40 bp VNTR in the 3′ UTR)

The 40 bp VNTR polymorphism of DAT1 in the 3′-UTR (repeat copy numbers 3-11) was genotyped using fragment analysis as well. The forward primer used in the PCR amplification, was fluorescently labeled with PET (Applied Biosystems, Foster City, Calif., USA) so the fragments could be analyzed on a 3130 Genetic Analyzer (Applied Biosystems). The sequence for the forward primer was 5′-PET-TGT GGT GTA GGG AAC GGC CTG AG-3′ (SEQ ID NO:5) and the reverse primer was 5′-CTT CCT GGA GGT CAC GGC TCA AGG-3′ (SEQ ID NO:6) as described previously. PCR reactions were performed using a PCR Master Mix (Promega, Madison, Wis., USA), containing 1× reaction buffer, 200 μM of each dNTPs and 1.5 mM Mg²+, 1.25 U Taq DNA polymerase, 25 pmols of each primers, 20 ng of genomic DNA in a 10 μl total reaction volume. Additional MgCl₂ was added to a final concentration of 4 mM of Mg²+, to reduce unspecific fragment amplification. The following conditions were used for thermocycling: initial 10 mins denaturing at 98° C., 45 cycles of 96° C. for 30 s, 68° C. for 30 s, 76° C. for 90 s and a final extension at 72° C. for 10 mins.

### DRD5 (Di-Nucleotide Repeat 18.5 kb Upstream of Transcription Start Site)

Genotypes for the DRD5 di-nucleotide repeat polymorphism (CT)ₙ 18.5 kb upstream of the DRD5 transcription start site were generated using fragment analysis on the ABI 3130 Genetic Analyzer (Applied Biosystems, Foster City, Calif., USA). Fragments were generated from a PCR reaction using the following pair of primers: forward (5′-NED CGT GTA TGA TCC CTG CAG-3′ (SEQ ID NO:7)) and reverse (5′-GCT CAT GAG AAG AAT GGA GTG-3′ (SEQ ID NO:8)) described previously. PCR reactions were performed using a PCR Master Mix (Promega, Madison, Wis., USA) containing 1.5 mM MgCl₂, 1× reaction buffer, 200 μM of each dNTP, 45 ng purified genomic DNA, 1.25 units Taq DNA polymerase, and 5 pmols of each primer in a 12 ul reaction. PCR cycling conditions consisted of an initial denaturation at 95° C. for 15 minutes, 35 cycles each consisting of 30 s at 94° C., 30 s at 58° C., and 40 s at 72° C. Elongation was continued for 15 min at 72° C. after the last cycle.

### MAOA (30 bp Tandem Repeat in Promoter)

The 30 bp VNTR polymorphism of MAOA (repeat copy numbers 2-5), an X-linked gene found 1.2 kp upstream to the MAOA start codon was genotyped using a 12.5 μl PCR reaction with the MasterTaq Kit (5 Prime, Gaithersburg, Md., USA). The PCR reaction contained 1.25 μl 10× TaqBuffer with Mg²⁺, 1.25 μl 5× TaqMaster PCR enhancer, 0.25 μl dNTP mix (10 mM each), 0.5 μl of both the forward and the reverse primers (5 μM), 0.25 μl Taq DNA Polymerase (5 U/μl), 5.0 μl genomic DNA template (10 ng/μl), and 3.5 μl molecular biology grade DH2O. The primer sequences have been defined previously. The forward primer was fluorescently labeled at the 5′ end with NED (Applied Biosystems, Foster City, Calif., USA) and the sequence was as follows 5′-NED CCCAGGCTGCTCCAGAAACATG-3′ (SEQ ID NO:9). The reverse primers consisted of the following sequence, 5′ GTTCGGGACCTGGGCAGTTGTG-3′ (SEQ ID NO:10). Cycling conditions consisted of an initial denaturation at 95° C. for 15 minutes, 30 cycles each consisting of 30 s at 94° C., 30 s at 59° C., and 40 s at 72° C. with an additional 15 minute elongation at 72° C. after the last cycle.

### Capillary Electrophoresis 3130 Genetic Analyzer

Fragment Analysis of DAT1, DRD4, DRD5 and MAOA were multiplexed together by combining PCR products in a specific ratio. Ratio optimization of the multiplexed DAT1, DRD4, DRD5 and MAOA PCR products was required for consistent fragment analysis genotype calls. The ratio of PCR products, Formamide, and the 1200LIZ size standard was as follows; 3.0% v/v DAT1 PCR product, 3.0% v/v DRD4 PCR product, 1.0% v/v DRD5 PCR product, 1.0% MAOA PCR product, 2.0% 1200LIZ size standard, and 90.0% Formamide. The overall reaction volume for each sample was 35.5 μl. The multiplexed reaction was separated in an Applied Biosystems 3130 Genetic Analyzer with a 36-cm array and POP-7 polymer.

Genotypes were determined using GeneMapper Software Version 4.0. Fragment peaks were inspected manually by two persons independently and results compared to accurately confirm genotype calls. Sizes for the different DRD4 alleles are as follows; 267 bp (2) repeats, 315 bp (3), 363 bp (4), 411 bp (5), 459 bp (6), 507 bp (7), 555 bp (8), 603 bp (9), 651 bp (10), 699 bp (11). Sizes for DAT1 alleles: 440 bp, 480 bp and 520 bp. Sizes for the different MAOA alleles are as follows: 233 (2) repeats, 263 bp (3), 278 bp (3.5), 293 bp (4), and 323 bp (5). Sizes for the different DRD5 alleles range from 130 bp through 160 bp in increments of 2.

SNPs used are listed in Table 1.

TABLE 1
SNP Reference Data.

| | rs No.; | | |
|---|---|---|---|
| SNP | Allele | Location | Descriptions/Associations |
| BDNF | (rs6265) | Location: UCSC, | C (Val) = vic = most common. |
| | | NCBI Assembly | T (Met) = fam = Minor Allele |
| | | 36/hg 18: | Frequency (MAF) = 0.2 caucasians. |
| | | Chr11: 2,36,67-2,636,17 | Met (A) may be protective against |
| | | | depression when subjected to |
| | | | repeated defeat. |
| | | | Depressed patient who exhibit GA |
| | | | or AA appear to show increased risk |
| | | | for suicidal behavior. |
| COMT | (rs4680); | UCSC, NCBI | A (Met) = vic = lower enzymatic |
| | Val158Met | Assembly 36/hg 18: | activity - worrier (memory/attention |
| | | Chr22: 18331246-18331296 | tasks) = MAF = 0.43. |
| | | | G (Val) = fam = higher enzymatic |
| | | | activity - warrior (processing |
| | | | aversive stimuli). |
| | | | Met/Met (A/A) associated with |
| | | | ADHD. |
| | | | Adolescent cannabis use associated |
| | | | with increased incidence of |
| | | | schizophreniform in adulthood |
| | | | among Val/Val (G/G). |
| | | | Better response with antidepressant |
| | | | paroxetine in Met/Met (A/A) |
| | | | compared to Val/Val (G/G). |
| | | | Intermediate response observed in |
| | | | heterozygotes. |
| DRD2 | rs1800497 | UCSC, NCBI | A1 = A = Vic = MAF = 0.2 |
| | | Assembly 36/hg 18: | caucasians = associated with lower |
| | | Chr11: 112776013-112776063 | gene expression. |
| | | | A2 = G = Fam. |
| | | | Homozygous (A2/A2) smokers |
| | | | using bupropion were more |
| | | | successful at quitting than |
| | | | heterozygous of homozygous |
| | | | (A1/A1) smokers. |
| | | | One study suggests A1 carrier |
| | | | status has a relationship with |
| | | | conduct disorder, behavioral |
| | | | phenotype of impulsivity, and |
| | | | problematic alcohol/drug use among |
| | | | adolescents. |
| | | | Male A1/A1 genotype with low |
| | | | birth weights = less education |
| | | | attainment in adulthood. |
| DBH | rs1611115; | UCSC, NCBI | C = Vic. |
| | 1021C > T intron | Assembly 36/hg 18: | T = Fam = contributes greatly to |
| | 5, Dopamine- | chr9: 135,490,311-135,490,361 | lower |
| | beta-hydroxylase | | DBH activity (risk allele) = MAF = |
| | | | 0.192. |
| | | | DBH enzyme catalyses the |
| | | | conversion of dopamine to |
| | | | noradrenaline. Low levels of |
| | | | noradrenaline are highly associated |
| | | | with Alzheimer's disease, therefore, |
| | | | T/T higher risk for Alzheimer's. |
| | | | Disulfiram effective treatment for |
| | | | cocaine addiction if individual is |
| | | | T/T. |
| | | | T/T homozygotes appear to be at |
| | | | increased risk for personality traits |
| | | | related to impulsiveness, aggression |
| | | | and related disease states, namely |
| | | | adult ADHD. |
| DBH | rs2519152 | UCSC, NCBI | T = A2 = Vic. |
| | | Assembly 36/hg 18: | C = A1 = Fam = MAF = 34.8% |
| | | chr9: 135,499,390-135,499,482 | European Caucasians. |
| | | | DBH levels found in plasma |
| | | | associated with ADHD. |
| | | | SNP may work in tandem with |
| | | | other DBH SNPs to influence DBH |
| | | | levels in plasma. |
| SNAP-25 | rs3746544; | UCSC, NCBI | G = Vic = MAF = 0.41. |
| | T1065G MnlI, | Assembly 36/hg 18: | T = Fam. |
| | synaptosomal- | Chr20: 10,235,059-10,235,109 | Increased risk of schizophrenia |
| | associated protein | | with G (C) allele. |
| | of 25 kDa | | Associated with higher risk for |
| | | | ADHD if have A(T) allele. |
| SNAP-25 | rs1051312; | UCSC, NCBI | |
| | T1069C DdeI, | Assembly 36/hg 18: | |
| | synaptosomal- | Chr20: 10,235,063-10,235,113 | |
| | associated protein | | |
| | of 25 kDa | | |
| NET | rs998424 | UCSC, NCBI | |
| | | Assembly 36/hg 18: | |
| | | Chr16: 54289422-54289472 | |
| NET | rs3785157 | UCSC, NCBI | |
| | | Assembly 36/hg 18: | |
| | | Chr16: 54287312-54287362 | |
| CLOCK | rs1801260 | UCSC, NCBI | Compared to T/T homozygotes, |
| | | Assembly 36/hg 18: | carriers of the C allele had a similar |
| | | Chr4: 55996101-55996151 | degree of severity of depression, but |
| | | | showed higher activity levels in the |
| | | | evening, a delayed sleep onset |
| | | | (mean 79 min later), and a reduced |
| | | | amount of sleep during the night |
| | | | (mean 75 min less). |
| | | | T mutation is the risk allele. |
| | | | Strong, significant association |
| | | | between adult ADHD and this |
| | | | polymorphism. |
| | | | obesity and metabolic syndrome. |
| | | | T/C (CGC haplotype on rs1801260) |
| | | | associated with lower waist and hip |
| | | | circumference and lower BMI. |
| | | | Suggest CGC may be protective for |
| | | | development of obesity. |
| ApoE | rs7412 | UCSC, NCBI | T/T = normal |
| | | Assembly 36/hg | Carriers of C allele were more |
| | | 18: chr19: 50103894-50103944 | likely to gain weight on olanzapine |
| | | | (atypical antipsych) compared to |
| | | | T/T homozygotes. |
| NPY | rs16139 | UCSC, NCBI | |
| | | Assembly 36/hg | |
| | | 18: chr7: 24291379-24291429 | |
| ADRA2A | rs1800545 | UCSC, NCBI | |
| | | Assembly 36/hg 18: | |
| | | Chr10: 112827503-112827553 | |
| TPH2 | rs1386497; | UCSC, NCBI | |
| | tryptophan | Assembly 36/hg 18: | |
| | hydroxylase 2 | Chr12: 70678532-70678582 | |
| DRD1 | rs265981; | UCSC, NCBI | |
| | dompamine | Assembly 36/hg 18: | |
| | receptor D1 | chr5: 174803483-174803533 | |
| KATII | rs13145318 | UCSC, NCBI | |
| | | Assembly 36/hg | |
| | | 18: chr: 4171227812-171227864 | |

### Study Design

The study design will be a non-randomized, case study retrospective and prospective comparison, proof-in-concept study. The study will consist of four phases:
data collection;
treatment plan assessment and recommendation;
treatment;
follow-up assessment.

### Data Collection and Baseline Assessment Phase

Informed consent will be obtained for subjects meeting the criteria for the study (see informed consent procedures). The following historical data from the subjects' medical records, and other additional information, will be collected:
DSM-IV Diagnosis
Current and Past Medications
Medication cost data
Relevant Laboratory Analysis
Other applicable treatments
Behavioral history
Base-line Emotional Problems Scale (EPS)
Saliva sample

### Treatment Plan Assessment and Recommendations

Data from all subjects will be analyzed for trends, and recommendations will be made based initially on generally acceptable utilization assessment standards. For example, a brand name may be modified to a generic. After general utilization assessment guidelines have been established for this population, the genetic data will be assessed for more specific guidance in each subject's case. For example, specific polymorphisms may be identified for a subject who has a significant alternation in metabolic enzyme of a drug which may be taken into consideration for treatment recommendations.

### Treatment

Once a treatment modification has been established and agreed upon by the treatment team, it will be implemented into the subject's routine for approximately the next six months. Periodic assessments will be made as appropriate for the subject and as needed by the individual. Treatment may be discontinued at any time in accordance with South Dakota Developmental Center procedure.

### Follow-Up Assessment

At the end of the treatment phase, the following will be collected:
EPS for Quality of Life
Cost utilization review
Medication usage/compliance
Laboratory measurements
Behavior changes.

### Study Population

The study will focus on a small defined population in South Dakota. The participants all reside at the South Dakota Developmental Center (SDDC), which serves a unique population of people with developmental disabilities and co-occurring psychiatric disorders. This population was selected after our research group was approached by the state to help them reduce individual patient's medication burden and optimize prescription therapy to improve clinical outcomes. There are currently 150 people residing at this facility, in which 11 utilize over $1,000 per month just for medications.

Those subjects, approximately 50 subjects in total, with high numbers of medications used per month will be approached to participate in the study. Eligibility of subjects will then be determined by the treatment team which consists of 3-4 of the following individuals: treating psychologist, behavior therapist, case manager, supervisors, counselors, dietitians, physician assistants, occupational therapists, and physical therapists.

### Visit Schedule

The schedule of visits will be based on the participant's normal follow-up care—“standard of care” delivered by the treating psychologist—and will be dependant on individual needs. The phases of the study will be followed by the treating physician, treatment team and study staff.

An attempt will be made to follow the treatment plan as closely as possible during the treatment phase of the study. Special assessment will be made in the case of serious or non-serious adverse events related to medication.

### Consent Procedures

All subjects and/or legally authorized representatives will sign an informed consent document explaining the study, expected outcomes, possible treatment and alternatives.

As an added precaution, the treatment team will act as an advocate for all subjects and will be involved in the informed consent process. All eligible candidates will be reviewed by this team, and if it is determined that there is not an adequate authorized representative, the subject will no longer be eligible for the study. An ombudsman will be present for all patient consents.

### Genetic Assessment

DNA Collection

Genomic DNA for genotyping will be collected from saliva using the commercially available collection kit Oragene-DNA (DNA Genotek, Inc., Ottawa, Ontario, Canada). Genomic DNA will be extracted and purified from the buccal cells in the saliva according to the manufacturer's instructions. The resulting DNA will be quantified using an ultraviolet (UV) spectrophotometer and diluted or concentrated to 60 ng/μl in a Tris-EDTA buffer (TE-10 mM Tris-HCl, 0.1 mM EDTA, pH 8.0) and stored at −20° C.

### Genetic Analysis Using the DMET Platform

Sample preparation and microarray processing will be performed according to Affymetrix protocols. In brief, 1020 ng of purified genomic DNA is prepared for multiplex PCR, according to strict protocol specifications. The multiplex PCR is performed using a commercially available kit (Qiagen).

The resulting PCR products are diluted in buffer and annealing takes place in a separate reaction for 18 hours. The gaps are filled through another PCR amplification procedure. Target DNA is cleaned up using a proprietary reaction mix, and the resulting DNA is visualized on a QC agarose gel to ensure proper target preparation. The resulting DNA will then be fragmented using Affymetrix-supplied DNA fragmentation enzyme (DNaseI) to produce fragments of optimal size for hybridization to the markers on the microarray (<180 bp). Following fragmentation, the digestion product size is confirmed in an additional QC check using a 4% agarose gel electrophoresis.

The resulting fragments will be end-labeled (biotinylated) using an Affymetrix-supplied DNA labeling reagent consisting of Biotin and the enzyme terminal deoxynucleotidyl transferase (TdT). The labeled products will then be mixed with a hybridization solution and denatured on a thermal cycler. The hybridization reactions are loaded onto a DMET microarray and hybridization will occur for 16-18 hours at 49° C. with 60 rpm of rotation.

Following hybridization, the arrays will be subjected to several cycles of two different buffer stringency washes—a Steptavidin Phycoerythrin (SAPE) stain cycle and an Antibody Stain cycle—followed by a second Streptavidin stain step and a final buffer wash before the microarray is finally filled with holding buffer. All of the wash and stain steps will be carried out in an automated Fluidics Station (Affymetrix). The arrays will be scanned in the GeneChip Scanner 3000 7G (Affymetrix) with an autoloader accessory. The command console software creates a (.DAT) file for each sample/array that is subsequently scanned. This file is captured by Affymetrix DMET Console 1.0 and converted to the standard intensity (.CEL) file where it can be stored and/or converted into different files for further analysis.

### Data Analysis

Microarray data will be analyzed in DMET Console 1.0. The Affymetrix-supplied software uses the data generated from the microarray to make genotype calls for all the markers on the array. A summary translation report will be generated from this software for the pharmacist and physicians to review for each sample. This will include detailed information for each of the markers on the array, enabling the research team to identify variants in genes that result in impaired drug metabolism. A simple column in this report will describe for each marker whether the sample participant is heterozygous for the reference allele and variant allele, homozygous for the reference allele, or homozygous for the variant allele.

### Emotional Problems Scale

The Emotional Problems Scale (EPS) consists of two complementary instruments, the Behavior Rating Scale (BRS) and the Self-Report Inventory (SRI). The EPS will be used as it was specifically designed for use as part of a comprehensive clinical evaluation in individuals, ages 14 years and older, with mild mental retardation or borderline intelligence.

The 135-item, 4-point BRS was designed to indicate how often a client has exhibited specific behaviors during the previous 30 days, according to the following categories: Thought/Behavior Disorder, Verbal Aggression, Physical Aggression, Sexual Maladjustment, Distractibility, Hyperactivity, Somatic Concerns, Depression, Withdrawal, Low Self-esteem, Externalizing Behavior Problems, and Internalizing Behavior Problems.

The 147-item, true/false SRI is written at a 4th-grade reading level and is designed to yield self report information, according to the following categories: Positive Impression, Thought/Behavior Disorder, Impulse Control, Anxiety, Depression, Low Self-esteem, and Total Pathology. All scores can be profiled on the EPS Profile Form (a).

### Diagnostic Testing

Psychometric testing will be carried out prior to entry into the study by the treatment team. Each subject has documented behavioral assessments and other psychometric testing completed on a scheduled basis by their treatment team. These results, including current DSM diagnosis, may be utilized in any analysis that will be completed.

### Pharmacological Assessment

A complete medication history will be provided prior to entry into the study. A psychiatric pharmacist will review this data, as well as any historical medication data that has been provided. Suggestions for optimization of medication regimens will be completed, as well as correlation analysis between medications and pharmacogenetic testing. These suggestions will be provided to the treatment team at the South Dakota Developmental Center as suggestions to improve the subjects' quality of care and to help reduce medication burden.

Although the invention has been described with reference to the above examples, it will be understood that modifications and variations are encompassed within the spirit and scope of the invention. Accordingly, the invention is limited only by the following claims.

All references cited herein are herein incorporated by reference in entirety.

We claim herein:

1. A method of predicting responsiveness to treatment of attention-deficit/hyperactivity disorder (ADHD) in a subject susceptible to developing ADHD with a compound selected from the group consisting of methylphenidate, amphetamine, atomoxetine, and bupropion, or a pharmaceutically acceptable salt thereof, comprising: (a) obtaining a sample of body fluid or other tissue from said subject, (b) isolating DNA from said samples and applying the DNA under hybridization conditions to a solid phase containing a plurality of nucleic acids which are selective gene markers for at least human dopamine transporter 1 (hDAT1), human dopamine receptor D4 (hDRD4), human dopamine receptor D5 (hDRD5), human serotonin transporter promoter region (h5-HTTLPR), human catechol-O-methyltransferase (hCOMT), human synaptosomal-associated protein 25 (hSNAP-25), human norepinephrine transporter (hNET) solute carrier family 6 member 2 (hSLC6A2), human serotonin transporter (hSERT), and human adrenoceptor alpha A2 (hADRA2A), (c) determining informative occurrences of one or more variable number of tandem repeat (VNTR) polymorphisms present in genes selected from the group consisting of hDAT1 (NM_{—}001044.4), hDRD4 (DQ846850.1), hDRD5 (NC_{—}000004.11), h5-HTTLPR (AC104984) and combinations thereof and (d) determining informative occurrences of one or more single nucleotide polymorphisms (SNPs) selected from the group consisting of hCOMT (rs4680); hSNAP-25 (rs3746544); hNET (rs998424); hNET (rs3785157); hNET (rs47958); hSLC6A2 (rs47958, rs36017, and rs2270935); hSERT (rs25331); hADRA2A (rs1800545) and combinations thereof in said subject's sample, wherein said occurrences of said one or more VNTR polymorphisms and said one or more SNPs in said sample correlates with said subject's response to treatment with said compound or pharmaceutically acceptable salt thereof.

2. The method of claim 1, where in the solid phase further comprises nucleic acids which are selective markers for human brain derived neurotrophic factor (hBDNF), human dopamine receptor D2 (hDRD2), human dopamine beta-hydroxylase (hDBH), human circadian locomotor output cycles kaput (hCLOCK), human apolipoprotein E (hApoE), human neuropeptide Y (hNPY), human tryptophan hydroxylase 2 (hTPH2), human dopamine receptor D1 (hDRD1), and human L-kynurenine/alpha-aminoadipate aminotransferase II (hKATII); and wherein the method further comprises confirming whether said subject is susceptible to developing ADHD by determining informative occurrences of one or more SNPs selected from the group consisting of hBDNF (rs6265); hDRD2 (rs1800497); hDBH (rs1611115); hDBH (rs2519152); hSNAP-25 (rs1051312); hCLOCK (rs1801260); hApoE (rs7412); hNPY (re16139); hTPH2 (rs1386497); hDRD1 (rs265981); hKATII (rs13145318); and combinations thereof.

3. The method of claim 1, wherein said compound is methylphenidate, or a pharmaceutically acceptable salt thereof, and wherein said VNTR polymorphisms comprise a combination of hDAT1, hDRD4, hDRD5, and h5-HTTLPR, and wherein said SNPs comprise a combination of hNET1 (rs3785157), hADRA2A (rs180054); hCOMT (rs4680); hSERT (rs25331); and hSNAP-25 (rs3746544).

4. The method of claim 3, wherein said method predicts an improved response to said compound when said VNTR polymorphism occurrences comprise 9 or 10 repeats in the 3′ untranslated region of hSLC6A3 (DAT1); 7 repeats in exon 3 of hDRD4; 4 repeats 18.5 kb upstream of the hDRD5 (NC_{—}000004.11), and wherein said SNPs occurrences comprise a G allele in the 5′ untranslated region of the HhaI RFLP of said hADRA2A; a VAL/VAL alleles at amino acid 158 of said hCOMT, wherein said subject is hyperactive or inattentive; and/or T/T alleles at the 3′ untranslated region of said hSNAP-25 (rs3746544).

5. The method of claim 4, wherein when said methods do not predict improved out come with methylphenidate or amphetamine, the predicted responsiveness is associated with a non-stimulant compound selected from atomoxetine or bupropion, or pharmaceutically acceptable salts thereof, and wherein said VNTR polymorphism comprises hDAT4 and said SNPs comprise hNET1.

6. The method of claim 3, wherein said method predicts a poor response to said compound when said SNPs occurrences comprise A/A alleles in hNET1 (rs3785157), G/G alleles in hSNAP-25 (rs3746544) and/or C/C alleles in hSNAP-25 (rs1051312).

7. The method of claim 1, wherein the compound is amphetamine, or a pharmaceutically acceptable salt thereof, wherein said VNTR polymorphisms comprise hDAT1 and wherein said SNPs comprise a combination of hNET1, hSLC6A2, and hCOMT (rs4680).

8. The method of claim 7, wherein said method predicts an improved response to said compound when said VNTR polymorphism occurrences comprise 9 or 10 repeats in the 3′ untranslated region of hSLC6A3 (DAT1), and wherein said SNPs occurrences comprise VAL/VAL alleles at amino acid 158 of said hCOMT, CC alleles at hNET1 36001A/C (rs47958) and the CGC haplotype at 36001A/C, 28257G/C (rs36017), and 28323C/T (rs2270935) in hSLC6A2.

9. The method of claim 7, wherein when said methods do not predict improved out come with methylphenidate or amphetamine, the predicted responsiveness is associated with a non-stimulant compound selected from atomoxetine or bupropion, or pharmaceutically acceptable salts thereof, and wherein said VNTR polymorphism comprises hDAT4 and said SNPs comprise hNET1.

10. The method of claim 9, wherein said method predicts an improved response to said non-stimulant compounds when said VNTR polymorphism occurrences comprise 7 repeats in exon 4 of hDRD4 (DQ846850.1), and wherein said SNPs occurrences comprise a G1278A allele at exon 9 in hNET1 (rs3785157).

11. The method of claim 9, wherein said method predicts an diminished response to said non-stimulant compounds when said SNPs occurrences comprise A/A alleles at exon 9 in hNET1 (rs3785157).

12. The method of claim 1, wherein responsiveness is determined by comparing one or more symptoms selected from the group consisting of inattention, hyperactivity, impulsivity, impatience, blurting, excessive talking, conduct disorder, social impairments and combinations thereof, exhibited by said subject before and after treatment.

13. The method of claim 12, wherein an improved response is achieved when said subject exhibits a significant reduction in one or more of said symptoms.

14. The method of claim 1, wherein the solid phase is a microarray on a substrate selected from the group consisting of a membrane, filter, chip, and glass slide.

15. The method of claim 1, wherein the sample is selected from the group consisting of blood, semen, saliva, tears, urine, fecal matter, sweat, buccal smear, skin, hair, and a biopsy of a specific organ tissue.

16. A kit comprising nucleic acids for identifying VNTRs and SNPs associated with a disease or disorder comprising:
a) at least one DNA chip comprising a plurality of oligonucleotide probes deposited on a solid phase, wherein the oligonucleotide probes consist essentially of human dopamine transporter 1 (hDAT1; NM_{—}001044.4); human dopamine receptor D4 (hDRD4; DQ846850.1); human dopamine receptor D5 (hDRD5; NC_{—}000004.11); human serotonin transporter promoter region (h5-HTTLPR; AC104984); hCOMT (rs4680); hSNAP-25 (rs3746544); hNET (rs998424); hNET (rs3785157); hNET (rs47958); hSLC6A2 (rs47958, rs36017, and rs2270935); hSERT (rs25331); hADRA2A (rs1800545); hBDNF (rs6265); hDRD2 (rs1800497); hDBH (rs1611115); hDBH (rs2519152); hSNAP-25 (rs1051312); hCLOCK (rs1801260); hApoE (rs7412); hNPY (re16139); hTPH2 (rs1386497); hDRD1 (rs265981); hKATII (rs13145318);
b) optionally two or more primers for PCR of fragments from a genomic nucleic acid sample, which products therefrom hybridize and form complexes with one or more probes on said at least one chip;
c) one or more buffers for forming informative complexes between the resulting PCR products and the plurality of oligonucleotide probes;
d) a manual which provides instructions on the use of said chip and optional primers; and
e) a labeled container for packaging said at least one chip, two or more primers, one or more buffers, and manual.

17. The kit of claim 16, wherein the solid phase is a DNA chip, wherein said DNA chip comprises a plurality of oligonucleotide probes, and wherein the oligonucleotide probes consist essentially of human dopamine transporter 1 (DAT1; NM_{—}001044.4); human dopamine receptor D4 (hDRD4; DQ846850.1); human dopamine receptor D5 (hDRD5; NC_{—}000004.11); human serotonin transporter promoter region (h5-HTTLPR; AC104984); hCOMT (rs4680); hSNAP-25 (rs3746544); hNET (rs998424); hNET (rs3785157); hNET (rs47958); hSLC6A2 (rs47958, rs36017, and rs2270935); hSERT (rs25331); hADRA2A (rs1800545); hBDNF (rs6265); DRD2 (rs1800497); hDBH (rs1611115); hDBH (rs2519152); hSNAP-25 (rs1051312); hCLOCK (rs1801260); hApoE (rs7412); hNPY (re16139); hTPH2 (rs1386497); hDRD1 (rs265981); KATII (rs13145318).

18. The kit of claim 16, wherein the primer pairs are selected from the group consisting of SEQ ID NO: 1 and SEQ ID NO:2, SEQ ID NO: 3 and SEQ ID NO:4, SEQ ID NO: 5 and SEQ ID NO:6, SEQ ID NO:7 and SEQ ID NO:8, and SEQ ID NO:9 and SEQ ID NO:10.

19. A method of predicting responsiveness to treatment of disorder or disease with a medicament comprising (a) obtaining a sample of body fluid or other tissue from said subject, (b) isolating DNA from said samples and applying the DNA under hybridization conditions to a solid phase containing a plurality of select genes, (b) determining informative occurrences of one or more variable number of tandem repeat (VNTR) polymorphisms present in select genes in said subject's sample and (c) determining informative occurrences of one or more single nucleotide polymorphisms (SNPs) present in select genes in said subject's sample, wherein said occurrences of said one or more VNTR polymorphisms and said one or more SNPs in said sample correlates with said subject's response to treatment with said compound or pharmaceutically acceptable salt thereof.

20. The method of claim 19, wherein said occurrences correlate with an improved response to said compound when said VNTR polymorphism occurrences comprise 9 or 10 repeats in the 3′ untranslated region of hSLC6A3 (DAT1); 7 repeats in exon 3 of hDRD4; 4 repeats 18.5 kb upstream of the hDRD5 (NC_{—}000004.11), and wherein said SNPs occurrences comprise a G allele in the 5′ untranslated region of the HhaI RFLP of hADRA2A; a VAL/VAL alleles at amino acid 158 of hCOMT, wherein said subject is hyperactive or inattentive; and/or T/T alleles at the 3′ untranslated region of hSNAP-25 (rs3746544).
